(19) United States
(12) Patent Application Publication
(10) Pub. No.: US 2008/0256099 A1
(43) Pub. Date: Oct. 16, 2008

(54) Method and System For Managing Data and Organizational Constraints

(75) Inventors: Amir Chodorov, Misgav Dov (IL); Boaz Schnapp, Herzelia (IL); Doron Friedman, Nes Ziona (IL)

Correspondence Address: BROOKS KUSHMAN P.C., 1000 TOWN CENTER, TWENTY-SECOND FLOOR, SOUTHFIELD, MI, 48075, US

(73) Assignee: STERNA TECHNOLOGIES (2005) LTD., Raanana (IL)

(21) Appl. No.: 12/067,534

(22) PCT Filed: Sep. 20, 2006
(86) PCT No.: PCT/IL06/01104

§ 371 Date: Mar. 20, 2008

Related U.S. Application Data
(60) Provisional application No. 60/718,309, filed on Sep. 20, 2005.

(51) Int. Cl. G06F 17/00; G06F 9/44

(52) U.S. Cl. 707/100; 707/E17.005

(57) ABSTRACT

A method and system for managing data and organizational constraints is provided. Data is collected and stored as records in a database and multi-dimensional matrices known as parameters are associated with each of the sets of records. The parameters are then processed using various formulae and functions and the results of the processing are kept separate from the parameters themselves allowing for a flexible and fast response to any change in any of the parameters. The dimensions of each parameter are defined to include zero or more properties configured to access the multi-dimensional matrices and each parameter is defined in relation to each of the dimensions of the parameter. The set of dependencies among the parameters form part of a large constraint propagation network so that any change to a value of one of the parameters will be propagated throughout the network.

### FIELD OF THE INVENTION

The present invention relates to the management of data and organizational constraints within a company's structure.

### BACKGROUND OF THE INVENTION

Computer-based data processing began by logging transactions digitally into computers. Very quickly, organizations realized that they are faced with huge amounts of raw data, and became aware of the need to maintain accumulators of raw data; for example, organizations realized that it is not enough to have a digital copy of all purchase orders, but that they also need a summary of sales for different periods of time. Thus, organizations worldwide started using databases, comprised of many tables, where each table summarizes some useful information from raw data.

The most popular methodology is relational databases, based on well-founded theoretical principles, which has been around for decades, and is still widely deployed. Instead of raw data, the data were now organized in well-defined tables. The main problem faced by industry is that of displaying information in many possible ways, for different people throughout the organization. This required the processing of the databases, which could take a lot of time. As markets demanded quicker response times, the need for online processing became clear.

One of the major innovations of the early 1990s was Online Analytical Processing (OLAP). The principle behind OLAP is simple: the organization would anticipate all the types of information needed for display. Then, instead, or in addition to relational databases, the organization will implement OLAP cubes (or hyper-cubes): these are multi-dimensional tables that contain within them all the possible views for the data. This means that these views can now be displayed online, almost in real-time, from the raw data.

Despite the advantages of OLAP, it has a one major disadvantage, namely; the OLAP cubes include all computations within them, in a hard-coded fashion. This means that: i) they take very long time to develop (typically measured in months or even years), and ii) they are rigid and are very difficult to change. These two limitations mean that OLAP is not well suited for the pace of the 21^{st} century. Organizations today cannot afford to wait months every time they make structural changes, such as mergers and acquisitions, new product lines, for example.

### SUMMARY OF THE INVENTION

The present inventors have realized that with the current trend in computation, which allows for very large memory space, the computer memory of today's server is, in practice, large enough to contain arbitrarily large amounts of data. Thus, all critical organization data may be maintained within the available memory.

Secondly, the present inventors have further realized that a clear separation should be maintained between data and computation. Raw data is collected and represented as multi-dimensional parameters. In contrast to the prior art, the data is only stored once, in a compact fashion. Since the parameters are kept in memory, today's computation power allows for on-demand computation of formulae from the parameters using the extracted data in real time. By keeping the formulae separate from the parameters, an unprecedented level of flexibility is possible. For example, any structural change in the organization may be captured within a very short time period of days or even hours.

A further feature of the present invention is the use of what may be termed “a new kind of Business Mathematics”, in how the relationships between parameters may be expressed. “Business Mathematics” permits the operation of well defined mathematical operations on the multi-dimensional parameters. Briefly, the unique properties of “Business Mathematics” include:

i) the definition of matrix operations based on semantic properties rather than indexes, and

ii) a built-in capability to manage time series with different temporal resolutions.

The “Business Mathematics” will be described in further detail hereinbelow.

The set of dependencies among the parameters form part of a large constraint propagation network. This means that any change to a value of one of the parameters will be propagated throughout the organization. These enterprise economic chain reactions (ECRs) take place in real time, and are vital in providing deep insights for decision making.

Additional features of the present invention include the display of “money surfaces”, such as amounts of money that are missing from the organization, or amounts of money that can still be added to the revenue or profit lines, for example. Each parameter is converted into an equivalent monetary unit, and the integrals of the values over the relevant time periods are displayed.

The present invention has a unique constraint-based structure, and thus is also a unique prediction tool. Prior art tools use mathematical and statistical tools for predicting future values of certain parameters based on past behavior. In the present invention, mathematical and statistical tools may be integrated with external tools for mathematical prediction.

In addition, financial assumptions may be mixed with mathematical predictions. Furthermore, the present invention allows for making future-based simulations, which take into account not only the individual trends of parameters, but also the constraints among different parameters. Finally, combining the power of prediction with constraint propagation, the present invention allows a unique, powerful, simulation tool.

There is thus provided, in accordance with an embodiment of the invention, a method and a system for the management of data. The method includes the steps of:

collecting and storing sets of records in a database within memory;

associating multi-dimensional matrices known as parameters with each of the sets of records; and

processing the parameters of the sets of records.

Furthermore, in accordance with an embodiment of the invention, the steps of:

associating including the step of defining the dimensions of each of the parameters, the dimensions including zero or more properties configured to access the multi-dimensional matrices; and

defining each of the parameters in relation to each of the dimensions of each of the parameters.

Furthermore, in accordance with an embodiment of the invention, the dimensions further include at least one of a group of properties including a unique identifier, a name and a comment field.

Furthermore, in accordance with an embodiment of the invention, each of the parameters further includes a time dimension and a temporal resolution.

The time dimension may include one of a group including constant, index and array time series.

Furthermore, in accordance with an embodiment of the invention, the time dimension for one of each of the parameters maybe different from the time dimension of at least one other parameters. The temporal resolution for one of each of the parameters maybe different from the temporal resolution of at least one other parameter.

Furthermore, in accordance with an embodiment of the invention, the step of processing may include the step of applying at least one function to at least one of the elements of the parameters.

Furthermore, in accordance with an embodiment of the invention, the parameters and the functions associated with the parameters may form a network structure.

Furthermore, in accordance with an embodiment of the invention, the function is a constraint and the parameters and the functions associated with the parameters form a constraint propagation network.

Furthermore, in accordance with an embodiment of the invention, the constraint may have a format of C(x₁, . . . , xₙ), where C is the type of the constraint and x₁, . . . , xₙ are parameters. The constraint may include a function having an inequality sign (=˜).

Furthermore, in accordance with an embodiment of the invention, the constraint propagation network may include a non-directional relationship between input and output parameters. The output of one function may become the input of another function.

Furthermore, in accordance with an embodiment of the invention, the parameters may be defined as a tuple: <I, T, R>, where I is the identity, T is the data type, and R is the temporal resolution.

Furthermore, in accordance with an embodiment of the invention, the parameters may be defined as a two-dimensional table with keys, wherein P={<p_{1,1}, . . . , p_{k,1}, v₁>, . . . , <p_{1,n}, . . . , p_{k,n}, vₙ>}; and wherein each tuple in the table is defined as an “entry”, each p_{i,j} is defined as a “property value” and each tuple p_{1,i}, . . . p_{k,i} is defined as an “entry key”.

In addition, there is provided, in accordance with an embodiment of the invention, a system for the management of data, which includes a schema server, a database server in communication with the schema server, a web server in communication with the schema server and a user alerter in communication with the web server. The database server provides storage for sets of records and the schema server is configured to associate multi-dimensional matrices known as parameters with each of the sets of records and to process the parameters of the sets of records within the memory of the schema server.

Furthermore, in accordance with an embodiment of the invention, the database server may further provide storage for at a least one of a group including organization schema, data snapshots, alerts and system configurations.

Furthermore, in accordance with an embodiment of the invention, the data snapshots are automatically updated whenever new data is input.

Furthermore, in accordance with an embodiment of the invention, on startup, the schema server reads organization schema and snapshot from the database into its memory and creates all containers, connectors, formulas and collectors associated therewith in its memory.

Furthermore, in accordance with an embodiment of the invention, the user alerter may include a program located on a user's workstation. The program may be configured to alert the user to take actions in cases when organization objectives may be affected.

Additionally, in accordance with an embodiment of the invention, the web server may be configured used to produce HTML pages, the HTML pages including at least one of a group of sites configured to provide the common daily activities for regular users, to define and maintain the organization core schema and provide: starting and stopping the schema server for backups, setting system access privileges, removing unneeded data snapshots from database, configuring system parameters and viewing system faults logs.

### BRIEF DESCRIPTION OF THE DRAWINGS

The present invention will be understood and appreciated more fully understood from the following detailed description taken in conjunction with the appended drawings in which:

FIG. 1 is a two-dimensional tabular view of sales parameters used with the method and system according to an embodiment of the present invention;

FIG. 2 is a two-dimensional tabular view of sales parameters of FIG. 1 after filtering has been applied;

FIG. 3 is a graphical illustration of time series behavior;

FIG. 4 is a graphical illustration of the use of transformation with the present invention;

FIG. 5 is a graphical illustration of the expected profit for 2005;

FIG. 6 is a graphical illustration showing the interpolation of profit of FIG. 5 from quarterly data into daily profit;

FIG. 7 is a schematic illustration of a simple constraint used with the method and system according to an embodiment of the present invention;

FIG. 8 is a schematic illustration of a constraint scheme according to an embodiment of the present invention;

FIG. 9 is a schematic representation illustrating profit for different business units according to an embodiment of the present invention;

FIG. 10 is a schematic graphical illustration showing the projected versus actual values representing an organization's performance;

FIG. 11 is a graphical illustration of the expected profit for 2005;

FIG. 12 is a schematic illustration of an equality constraint scheme according to an embodiment of the present invention;

FIG. 13 is a schematic illustration of a dial connected to the profit parameter;

FIG. 14 is a schematic illustration of the profit parameter connected to an alarm;

FIG. 15 is a schematic illustration of the system modules according to an embodiment of the present invention;

FIG. 16 is a schematic illustration of the database snapshots;

FIG. 17 is a schematic illustration of a system tray icon;

FIG. 18 is a schematic illustration of a financial status gauge, trend gauge and volume indicators used with an embodiment of the present invention;

FIG. 19 is a schematic illustration of a network tunnel connecting system servers;

FIG. 20 is a schematic illustration of schema servers network used with an embodiment of the present invention;

FIG. 21 is a schematic illustration of a forecast method;

FIG. 22 is a graphical illustration of monthly sales values;

FIG. 23 is a graphical illustration of monthly sales values of FIG. 22 after smoothing extrapolation;

FIG. 24 is a graphical illustration of monthly sales values of FIG. 22 after extrapolation using trend analysis and seasonality;

FIG. 25 is a graphical illustration of monthly sales values of FIG. 22 after extrapolation using linear regression;

FIG. 26 is a graphical illustration showing the effects of auto correlation coefficients on FIG. 25; and

FIG. 27 is a schematic illustration of the effects of fusion prediction on the graph of FIG. 25.

### DETAILED DESCRIPTION OF THE PREFERRED EMBODIMENTS

The present invention utilizes innovative concepts and technologies for the management of data and organizational constraints within a company's structure. In the present invention, a clear separation is maintained between the raw data and the computation of the data. The raw data is represented as multi-dimensional parameters, which constitute the atomic blocks of the present invention.

The raw data is packed into a special data representation, known as parameters, which allows for flexibility and speed in processing. Parameters are a type of multi-dimensional matrices. Unlike standard algebraic matrices, the parameters of the present invention are not comprised of ordinary row and column vectors, and the cell elements are not referred to by a set of indexes, but the parameters have a semantic structure, and the single cells are referred to by their semantic properties, rather than by their indexes.

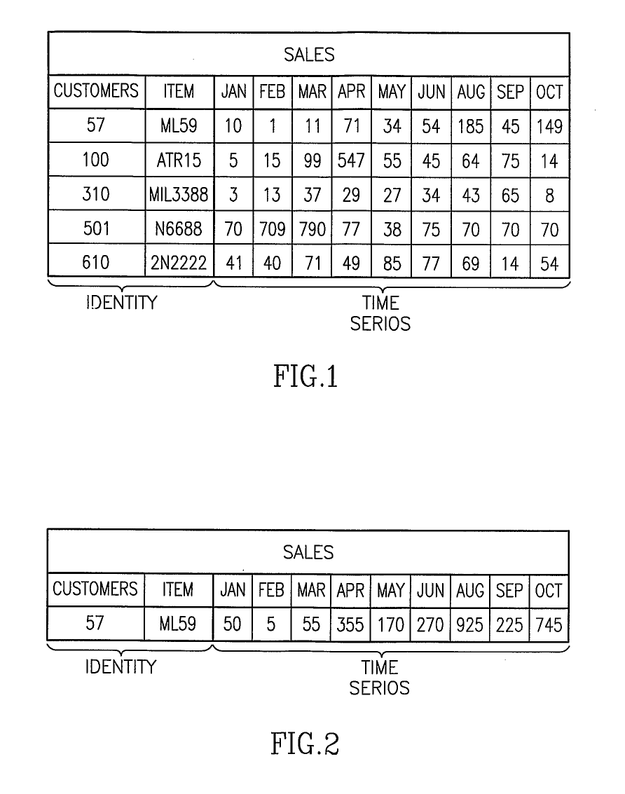

Reference is now made to FIGS. 1 and 2. FIG. 1 is a two-dimensional tabular view of sales parameters and FIG. 2 is a two-dimensional tabular view of sales parameters after filtering has been applied;

### Parameters

Each parameter may be associated with specific properties. For example, assuming that we are interested in customers and items sold by a specific unit. There are perhaps hundreds of customers and dozens of items. Requiring the user to define each combination separately is time consuming and inefficient.

Instead, a multi-dimensional parameter, which is actually a table of values, may be defined. A shown in FIG. 1, the table has two dimensions: customers and items. As will be appreciated by persons knowledgeable in the art, additional dimensions may be added.

### Properties and Identities

In order to define a parameter, its dimensions (or properties) need to be defined. For example, a property called ‘customer’, may be defined by providing the list of customers for that unit. The list will typically be extracted from the database. This means whenever there a new customer is entered, this is automatically reflected within the parameter.

Similarly, an additional property for the items sold by the unit may be defined. Each property may include a unique identifier, a name, and an optional comment field.

Once the properties in the system have been defined, the parameters themselves may be defined. In the example of FIG. 1, a parameter, called “sales” (for example), reflecting the sales per item per customer of our unit may be defined, by attaching the ‘sales’ parameter to the properties of ‘items’ and ‘customers’.

The parameter may be defined as a tuple: <I, T, R>, where/is the identity, T is the data type, and R is the temporal resolution. The identity of a parameter is determined by the set of properties associated with it—(the properties may be empty). The data type specifies the type of values, such as integers, floating point numbers, for example.

Temporal resolution is described below. In addition to these main characteristics, parameters may also be associated with additional features, described below.

There are two equivalent views for parameters: either as matrices with an arbitrary number of dimensions, or as two-dimensional tables with keys. Formally, the tabular (two-dimensional) view of a parameter can be written:

P={<p_{1,1}, . . . , p_{k,1}, v₁>, . . . , <p_{1,n}, . . . , p_{k,n}, vₙ>}.

Each tuple in the table may be called an entry, each p_{i,j} a property value, and each tuple p_{1,i}, . . . p_{k,i} an entry key.

Thus, if there are n data entries, k properties (dimensions), p_{i,j} is the property-value of the i-th property in the j-th entry, and vⱼ is the value of the j-th entry.

It should be noted that if a parameter has a matrix with N elements in the multi-dimensional view, the equivalent tabular view needs to have exactly N entries. If the tabular view does not have entries that specify values for all cells in the multi-dimensional view, those cells may be assigned with a unique value called NaN (not a number). As will be explained below, formulae need to be able to refer to these values correctly—they may be treated as 0s, 1s, or otherwise, depending on the context.

As will be explained below, all parameters include time as an additional, distinctive dimension. Thus, the value v is, in fact, a time series, or a vector. FIG. 1 shows the above parameter having temporal resolution of months

### Formulae

Parameters are connected by formulae of the form y=f(x₁, . . . , xₙ), where y is the output parameter and x₁, . . . , xₙ are the input parameters. The operator f is one of a large, pre-defined set of operations supported by the system of the present invention. In addition, the system architecture permits the addition of new operators into the system.

The formulae are configured to handle multi-dimensional parameters, each one having its own time dimension. For the purpose of simplicity, the time dimension is ignored, and each cell in the parameter contains a single value. The definitions will be expanded to handle the time dimension, as described hereinbelow.

### Simple Unary Operations

The simplest operations take one parameter as argument and modify every element in the parameter by applying a function to it. As an example, consider computing the absolute value and computing the square of values.

The formal definition is as follows: using the 2D representation we can write P={p1, . . . , pk, v}.

### Projections

Whenever reference is made to a parameter, in effect, the whole matrix of values is being referred to. In many cases a more abstract view of the parameter may be desired, which ignores some of the division induced by multiple dimensions. Special formulae may be defined, which reduce the dimensions of a parameter, by accumulating rows or columns according to properties.

It is not enough to specify which property to accumulate, but it is also necessary to specify how it should be accumulated. For example, referring to the sales per item, regardless of the customers, the customers should be accumulated using a sum operation. This is an exemplary case, but it will appreciated that there are many other cases where accumulation may be required using other types of operations, such as computing the average, minimum, maximum, for example.

Thus, an entity called a reduction may be defined as: r=<p,f>, where p is the property to be accumulated and f is the function to be applied for the accumulation. This allows for different accumulations to be derived from a single parameter, using the notation P[R], where R is a “projection”, or a vector of reductions applied on the parameter P. Naturally, if we denote by J the set of properties referred to by R, we expect J [symbol] , i.e., if R includes a reduction <p,f> s.t. p∉I then it is ignored. It should also be noted that the order in which the reductions are applied is important. That is, there are cases where P[<r1,r2>]≠P[<r2,r1>].

For example, sales[{<customer,+>})] specifies that the two-dimensional parameter sales be reduced with a projection that includes one reduction. This reduction, <customer,+>, specifies that the values for all customers be accumulated. This expression generates a one-dimensional parameter of total sales according to items. In this example, the additional time dimension has not been included.

Shorthand notations may be allowed. For example, if the projection only includes one reduction we omit both set and tuple brackets. In the example above, sales[customer,+] may be written.

Formally, a reduction may be defined as follows:

P={<p_{1,1}, . . . , p_{k,1}, v₁>, . . . , <p_{1,n}, . . . , p_{k,n}, vₙ>}.

To define the result of applying a reduction with property m, 1≦m≦k, <pₘ,f>:

Ψ(P)={<p_{1,1}, . . . , p_{m-1,1},p_{m+1,1}, . . . , p_{k,1},v₁>, . . . , <p_{1,n}, . . . , p_{m-1,n}, p_{m+1,n}, . . . , p_{k,n},v₁>}.

Ψ(P) still includes n entries, but for some of them there may be entries with equal keys, so Ψ(P) is not a well-defined parameter. P includes n entries, but Ψ(P) includes only, say, L different keys, L≧N.

E, a set of L new entries, may be defined as:

1≦i≦l,Eᵢ=<lⱼ,uᵢ>.

Eᵢ comprises <e₁, . . . , eₛ> entries from P's original entries as follows. Iᵢ is the ᵢ-th key, and if v(e) is the value of the entry, then uᵢ=f(v(e₁, . . . , eₛ).

Then E is exactly the list of entries for the parameter after reduction, or P[pₘ,f]=E.

Next, assuming sales3 is a 3-dimensional parameter, with the following three properties in its identity: customer, item, and sales-representative. In this case, in order to generate a one-dimensional parameter with total sales per customer the equation is:

sales_per_customer=sales3[<<item,+>,<sales-rep,+>>]

If a projection includes several reductions r1, . . . , rk, with properties p1, . . . , pk, and all have the same operation f, then a shorthand notation may be used. Thus, instead of writing P[<r1, . . . , rk>], the equation becomes: P[<p1, . . . , pk>,f].

In the example: sales_per_customer=sales3[<item, sales-rep>,+]

Alternatively, the result may itself be a multi-dimensional parameter. For example:

sales_item_customer=sales3[sales-rep,+]

The results, sales_item_customer, has two properties: items and customers, and is exactly identical to the sales parameter defined above (assuming both are based on the dame data from unit A).

### Filters

Reference is now made to FIG. 2, which is a two-dimensional tabular view of sales parameters of FIG. 1 after filtering has been applied.

In order to extend the expressiveness of the parameters, a generalization of reductions called “filters” may be applied. Filters allow for arbitrary parts of a parameter to be referred to. In this case, the predicate is expressed using SQL notation. For example, the formula:

sub_sales=sales[customer<200 and item like “M%”]*5;

will produce the result in sub_sales, as displayed in FIG. 2.

It should be noted that a filter serves as a projection if it only includes the equality operator. With other operators, regardless of the number of rows returned by a specific computation, the identity of the result does not change. As a result of a filter, it is also possible to create a parameter with no data.

Filters support the following operators: <, =, >, ≠, ≦, and ≧.

### Binary Operations

As a further extension of the application, binary operations, which involve formulae that apply to two parameters may be used.

Typically, binary operations will be element-wise. Initially, the method of carrying out binary element-wise operations for one-dimensional parameters may be defined.

Assume P₁ and P₂ are two parameters with one dimension each, both with the same property.

Each parameter may be represented as a set of <property-value, value> couples: P₁={<p₁,v₁>, . . . , <pₖ,vₖ>} and P₂={<q₁,u₁>, . . . , <qₘ,uₘ>}. For A={p1, . . . , pk} and B={q1, . . . , qm}, we define C={r1, . . . , rn}, C=A∪B.

An extension of P from A to C, written P[A−>C], may be defined as follows: ∀i, if exists j s.t. rᵢ=pⱼ then vᵢ=vⱼ, otherwise vᵢ=0.

Thus, in order to apply a binary element-wise operation on P₁ and P₂, they need to be extended. P₁′=P₁[A−>C], P₂′=P₂[B−>C]

Thus, P₁′={<p′₁,v′₁>, . . . , <p′ₖ,v′ₖ>} and P₂={<q′₁,u′₁>, . . . , <q′ₘ,u′ₘ>}, and A′={p′₁, . . . , p′ₖ} and B′={q′₁, . . . , q′ₘ}.

For an element-wise binary operation b, b(P1′,P2′)={<r₁,w₁>, . . . , <rₙ,wₙ>} where for every i there are now a j s.t. rᵢ=p′ⱼ and a k s.t. rᵢ=q′ₖ, so wᵢ=b(p′ⱼ, q′ₖ).

For example, assume R is a one-dimensional parameter of revenues per business unit, and E is a one-dimensional parameter of expenses per units. Both parameters have the same identity, which includes one property—BU. We can then write the basic formula: P=R−E, i.e., the profit as the difference between revenues and expenses, per business unit. Note that this operation is well-defined even if, for some reason, R and E do not contain exactly the same BUs. For example, if a unit has no revenues, and does not appear in R but appears in E, then R will be extended into a temporary parameter R′, with a value of 0 for this BU.

In a further example, based on the sales3 parameter mentioned above, assume there are parameters with the prices of items: Prices=<{items}>, that is, the data type and temporal resolution may be ignored for simplicity and Prices is a one-dimensional parameter. The formula may then be written as:

total_sales_per_item=sales3[<customer,sales_rep>+]*Prices

This generates a one-dimensional parameter, total_sales_per_item, by multiplying the quantities sold from each item by its price. This is equivalent to writing the following two formulae:

sales_per_item=sales3[<customer,sales_rep>,+]

total_sales_per_item=sales_per_item*Prices

Note that the * operation is an element-wise multiplication, rather than matrix multiplication. Each element in one matrix is multiplied by the corresponding element in the other matrix. Unlike algebra, where the correspondence is according to index, in the business algebra of the present invention, the correspondence is done by property. This means that the operation is well defined even if the vectors in the parameters are not of the same size, or if there are items for which there is an entry in only one of the parameters.

Also, it should be noted that the two parameters have exactly the same property-items. Otherwise, the multiplication would have been meaningless and would result in an error. It should be noted that the extension of the definitions above to operators with more than two parameters is straightforward.

As previously mentioned, the operations are only defined if applied on the same property.

The definition may be extended to operations between two parameters, where one's identity is a subset of the identity of the other.

As an example, by multiplying the number of items sold by item prices, the example of:

total_sales_per_item=sales3[<customer,sales_rep>,+]*Prices

may be rewritten as follows:

total_sales_per_item=sales3*Prices

In this case, since prices has one property—items—the computation may be applied to that property alone, and the reduction to sales3[<customer,sales_rep>,+] may be carried out by itself.

The formal definition is as follows. Assume two parameters P1 and P2, with identities I1 and I2 correspondingly, s.t. 12 [symbol] 1, and I1∩I2={p}. Then if J=I1−{p}, then b(P1,P2)=b(P1[J,+],P2), and the latter was defined above, since the first parameter now has one property in its identity. Note that “+” is the default reduction function, and for this reduction the order of applying the reductions is irrelevant.

The definitions above assumed the operations are only element-wise. It is straightforward for them to be extended to vector operations and matrix operations. The difference is that rather than using row and column indexes property-values may be used as keys. For example, the formula:

total_sales=sales3*Prices

computes a single value—the total amount of sales—using the dot product operation.

### Data Synthesis and Collectors

One of the main problems in current BI tools is that it takes a very long time to configure them to access the various databases in an organization. In an additional feature of the invention, a powerful mechanism called collectors, may be utilized to solve this problem.

Collectors are utilities that can be easily configured, using a simple scripting language, in order to access various types of databases and collect the data into the parameters of the invention.

A single data parameter may have several sources. Each source provides a different temporal aspect of the parameter. For example, one source may have information regarding material consumption in the past, another data source provides open orders from suppliers, and a third source may supply consumption planning based on production-planning data, consumption planning based on sales forecasting and average material waste caused during production process.

Current BI tools cannot handle this variety of sources, and require lengthy custom development. The present invention introduces a special solution for working with multiple sources, inspired by military and aviation control systems. Several parameters each containing different perspectives of the entire data coming from different sources, may be defined. All the parameters may be fed into a unique type of synthesis formula, which examines the different parameters' relevance ranking. The process results in combined periodic values that are based on the reliability of each source in every predicted period.

Additional technical details related to an exemplary implementation for collectors is described hereinbelow.

### Time Management

As briefly mentioned hereinabove each parameter comprises a series of values over time.

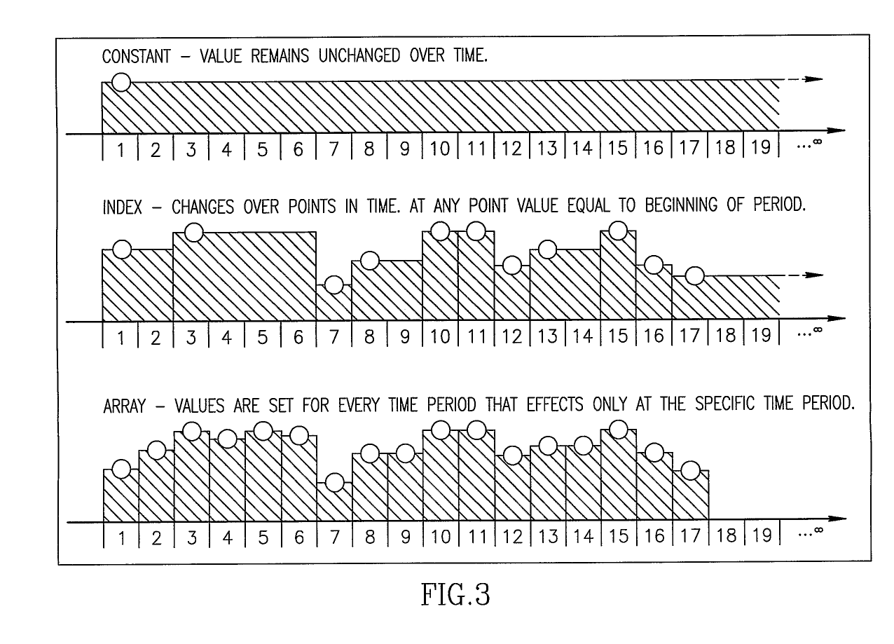

Reference is now made to FIG. 3, which is a graphical display of time series behavior.

### Types of Time Series

The present invention defines three types of time series (shown in FIG. 3), each of which shows a daily resolution and provides optimal storage and arithmetic behavior in formulae execution. The time series include:
1) Constant—value remains unchanged over time.
2) Index—value only changes at specific points in time. In between the points in time the value of the data remains unchanged and is equal to the value of the beginning of the period. For example—currency exchange rate, prices.
3) Array—value is set for every time period—values are in effect only at the specific time period with respect to the array temporal resolution.

### Temporal Resolutions

Different parameters may require different resolutions. For example, certain parameters may be assigned a forecast value only once per quarter, others may be assigned a value on a weekly basis, and so on. Some values may be updated on a very frequent basis. For example, if a call center is being tracked, some parameters may require to be updated every few seconds. Thus, for each parameter, a temporal resolution needs to be defined.

When managing time, calendar issues such as work days, holidays, leap years, for example may be taken into account.

### Temporal Transformations

Formulae may involve parameters with different temporal types and resolutions. Transformations among types and resolutions is similar to type casting in programming languages, as described below.

Assume we have parameters of three types: C (constant), I (index), and A (array). Specifically, the third type may come with different resolutions, denoted by R1,R2, etc.

Unary operations are relatively simple since they preserve the temporal type and resolution of the parameters. For a binary operation f, the resulting temporal types may be as follows.

Assuming C<I<A, then for every f(T1,T2), where T1 and T2 are the temporal types of the parameters, the result is of temporal type max(T1,T2).

This is also true for temporal resolution: f(R1,R2) is of type max(R1,R2), where a resolution is considered larger if it is more refined.

Assignments are unique, since in assignment the type or resolution of the parameter is not changed. It should be noted that, in one embodiment, assigning type I or type A into a constant parameter may be illegal. Assigning an array into an index, results in an index, with new values according to the resolution of the array. This is not an error, though it is not generally recommended owing to performance issues.

Similarly, assigning a constant to an array type parameter might result in a waste of memory space. Finally, assigning an array parameter of one temporal resolution to an array parameter with another temporal resolution requires converting the right-hand operand to the left-hand operand, using rollup and roll-down operations, as will be described below.

### Temporal Resolution Transformations

Formula computation may require manipulation of parameters that are comprised of data in different time-resolutions. In order to perform proper computing, several types of time-transformation plugs are used. Time transformations may be understood with reference to the following example:

Considering a simple formula such as;

P=R−E

where the parameter P represents the company profit and its defined time-resolution is quarters, which means that the organization profit should we measured on a quarterly basis. The parameter R is the company revenue, having values for every day, and the E parameter is the company expenses—measured on a monthly basis.

In order to compute this expression, all the values are transformed to a common temporal resolution. In this example, the daily values of the revenue parameter and the sum of monthly values of the expenses parameter for each quarter are to be summed. In order to accomplish this, the present invention uses a sum transformation plug. This transformation takes a higher temporal-resolution parameter and converts it to a lower resolution parameter. This type of transformation is called “rollup”.

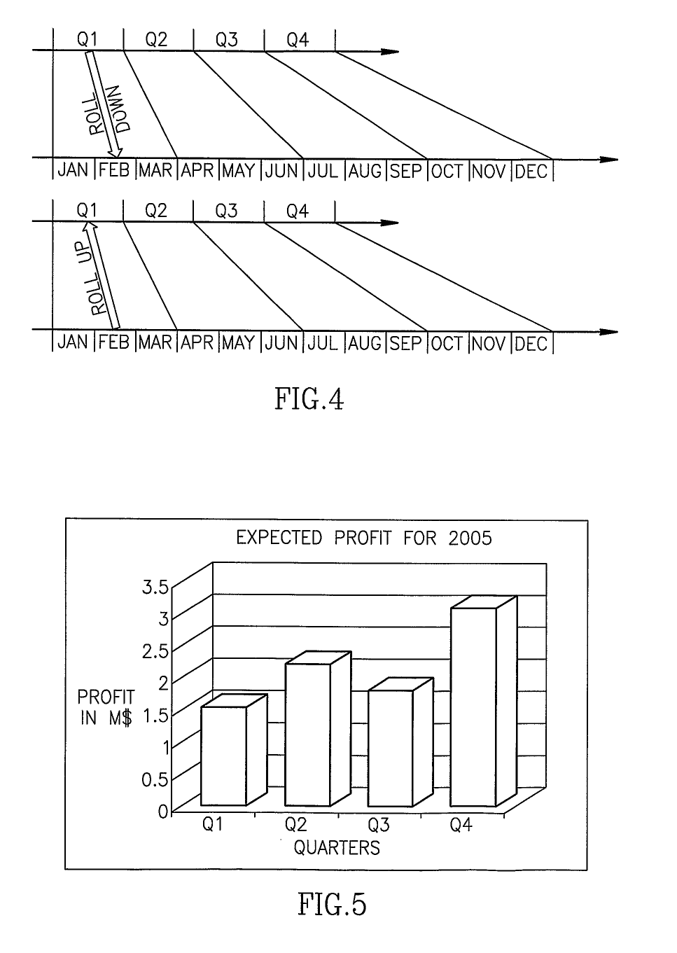

The present invention also uses “roll-down” transformations, which take a lower temporal-resolution parameter and convert it into a higher resolution parameter. It should be noted that a roll-down transform requires interpolation, as will be described hereinbelow. FIG. 4 graphically illustrated the transformation from 12 months (upper graph) into 4 quarters (lower graph).

The present invention uses many kinds of temporal-resolution transformations to perform a wide variety of computations. In addition, due to The present invention's plug-in architecture, custom transformations may easily be added to the system.

The following list contains a few examples of transformations used by the present invention:
1) Sum—A rollup type transformation which takes a higher temporal resolution data and groups it to lower temporal resolution data by summing the data for each group.
2) Avg—A rollup type transformation which takes a higher temporal resolution data and groups it to lower temporal resolution data by computing the average value for each group.
3) Min/Max—A rollup type transformation which takes a higher temporal resolution data and groups it to lower temporal resolution using the minimum/maximum value of each high resolution data group.
4) First/Last—A rollup type transformation which takes a higher temporal resolution data and groups it to lower temporal resolution data using the first/last value of each high resolution data group. This transformation is used, for example, for retrieving foreign currency exchange rate for periodic payments (i.e., the Euro rate at the first day of every month).
5) Linear Completion—A rollup type transformation that handles incomplete time periods (i.e. periods in the present for which the entire data is not available, such as the current quarter, current month etc.). In order to apply the completion transformation, it implements linear extrapolation to predict the whole period sum. This is also the most basic type of prediction supplied by the present invention.
6) Calendar Linear Completion—A rollup type transformation, similar to linear completion, which takes into account calendar and seasonality.
7) Reduction Linear/Reduction Calendar—This transformation is designed to handle incomplete time periods. It is designed to convert full data of a complete period of time (e.g., a month) to the relative data for a partial period of time (e.g., the first week of the month). It is commonly used for checking up to date data against the target for the entire period, for example, when checking the organization up to date sales data of the first week of the month against the target of sales for the entire month. The transformation calculates the target for the first week in the month so it can be compared with the actual sales data.

### Interpolations

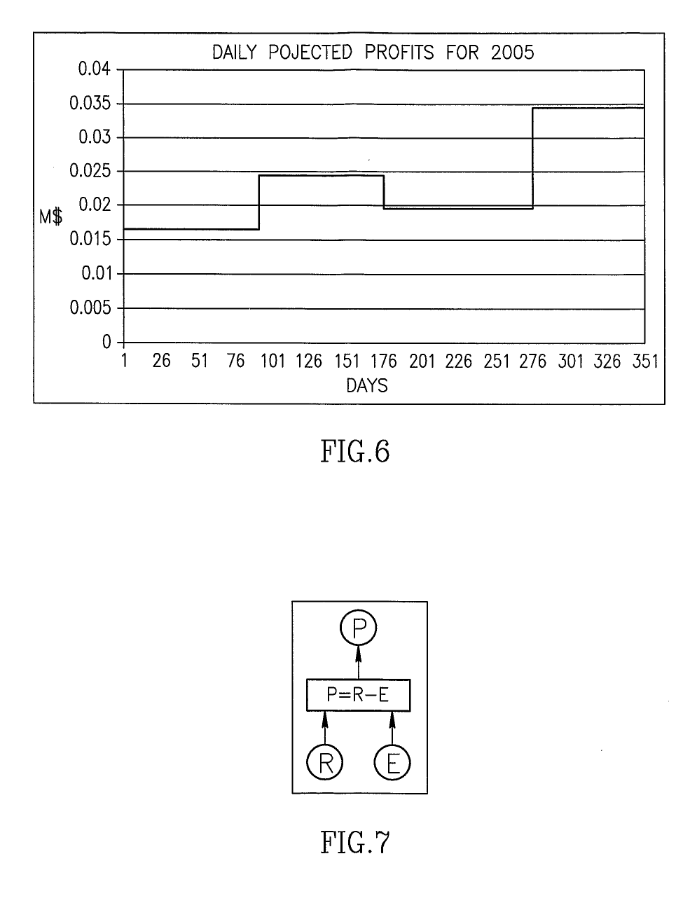

Roll-down operations often require interpolation. For example, in order to be able to compare actual profit against projected profit on a daily basis, assumptions need to be made regarding the daily profit from the quarterly profit. One assumption is that the profit each day is the total quarterly profit, divided by the number of days in the quarter. If the expect profit is as given in FIG. 5, this will result in a profit interpolation as in FIG. 6.

It may seem that this interpolation seems wrong since it does not take into account trends. This may be achieved by a curve that takes the trend into account, and for which the area under the graph, or the integral, is equal to the total money surface for that quarter.

Finding the right curve, or function, which satisfies these constraints, is known as function fitting, and can be done by solving a set of equations. A continuous or a discrete timeline may be assumed. If linear interpolation is assumed, then three equations with three unknown variables: a, b, and t₂ may be solved. The variables a and b define the function, and t₂ is the top of the curve for that quarter. Note that t₁ is known, because it is the profit in the last day of the last quarter. The equations are:

$${y}_{1} = a \cdot {t}_{1} + b$$

$$y 2 = a \cdot {t}_{2} + b$$

$${\int }_{t 1}^{t 2} P ( t ) d t = C \\ ⇒ \frac{a \cdot {t}_{1}^{2}}{2} + b \cdot {t}_{1} - ( \frac{a \cdot {t}_{2}^{2}}{2} + b \cdot {t}_{2} ) \\ ⇒ C = \frac{a}{2} \cdot ( {t}_{1}^{2} - {t}_{2}^{2} ) + b \cdot ( {t}_{1} - {t}_{2} )$$

From these equations it is easy to find a, b, and t₂. This provides the required interpolation. Thus, at every point in time during the quarter the expected profit according to the trend may be known.

An alternative way of looking at the same computation is assuming discrete values. At the beginning of Qi, the daily value of the variable being interpolated (e.g., the profit) is x. By the end of Qi the profit of C (the money surface) is required. If the same rate as in the first day is taken, the profit will be x·D. If more profit in this quarter is desired, it is necessary to know by how much the profit needs to be increased every day to achieve the goal; that is, we are interested in the difference:

C′=C−x·D

Assuming linear growth (this could also work if the profit in this quarter is lower than x·D, i.e., a negative trend), then the quota needed to add each day, denoted by z, may be computed according to the following formula:

$${\sum }_{i = 1}^{D} z \cdot i = {C}^{′} ⇒ z \cdot \frac{D ( D + 1 )}{2} = {C}^{′} ⇒ z = \frac{2 {C}^{′}}{D ( D + 1 )}$$

The computations above have assumed a linear interpolation. Non-linear methods will be described below. It should be appreciated that using plug-in architecture, these non-linear extrapolations may also be used for interpolation.

### Constraint Propagation and Organization Schema

The parameters and the formulae connecting the parameters form together a large network structure. The present invention allows treating the formulae as constraints, and the network structure thus becomes a constraint propagation network. This means that the impact of a small change globally may be tacked throughout the organization, following enterprise economical chain reactions (ECRs).

Formulae are typically regarded as directional; given the value of the inputs to the formulae, we expect the result to be computed. The present invention, on the other hand, allows modelling the organization in terms of “relations”. Each formula is turned into a constraint, expressing the relation among input and output parameters in a way that is not directional. The formulae, or constraints, are then connected into a large network structure, where the connections are the parameters. Thus, for example, the output of one formula becomes the input of another formula.

The network of constraints and parameters is also called the “organization core scheme” (OCS). The computation of such a scheme may proceed as follows:

When a parameter is assigned a new value (from an external source or by the user), it causes a new computation of all the constraints it is connected to. This, in turn, may cause further changes in parameter values, and the change propagates further to all constraints associated with that parameter. Thus, any small change of a value may trigger a “chain reaction” of updates throughout the organizational scheme. The solution presented by the present invention includes novel optimizations for handling constraints over multi-dimensional parameters.

Constraint propagation as applied to corporate management is now described with reference to a very simple example. The simplified example is presented here as an introduction. First, considering the simple formula:

Profit=Revenue−Expenses

Knowing the company revenue (for some duration) is R and the expenses is E, then the profit P can be computed, as follows:

P=R−E

However, if this formula is considered as a constraint, it is equivalent to three formulae:
1) If we know that the company revenue is R and the expenses are E, then the profit P is P=R−E.
2) If the company profit needs to be P, and the expenses are estimated to be E, then revenue of R is required, where R=P+E.
3) If the company profit needs to be P, and the revenues are estimated to be R, then the expenses must be E, where E=R−P.

Treating the formula as a constraint, it can be used to evaluate the effects of value changes. Typically, the value for one variable is sought when all the other variables are known.

In general, constraints have the following format:

C(x₁, . . . , xₙ)

Where C is the type of the constraint, which dictates the kinds of computations, and x₁, . . . , xₙ are the participating parameters. Generally, the order of the parameters is important. Parameters are defined below.

The constraints may be displayed in a graphical way, as shown in FIG. 7.

The various constraints may be connected. Assuming that the revenues are a sum of the revenues of two different business units (BUs), A and B, their revenues may be denoted as R_{A} and R_{B}, respectively. A new constraint is then added:

R=R_{A}+R_{B}.

Note that this is a constraint, not just a formula. So, for example, if a target revenue of R is assigned to the whole organization, unit A's revenue is known, the revenue required from unit B may be found from this constraint.

Also, assume that the expenses are a result of three units: A, B, and C, or:

E=E_{A}+E_{B}+E_{C}

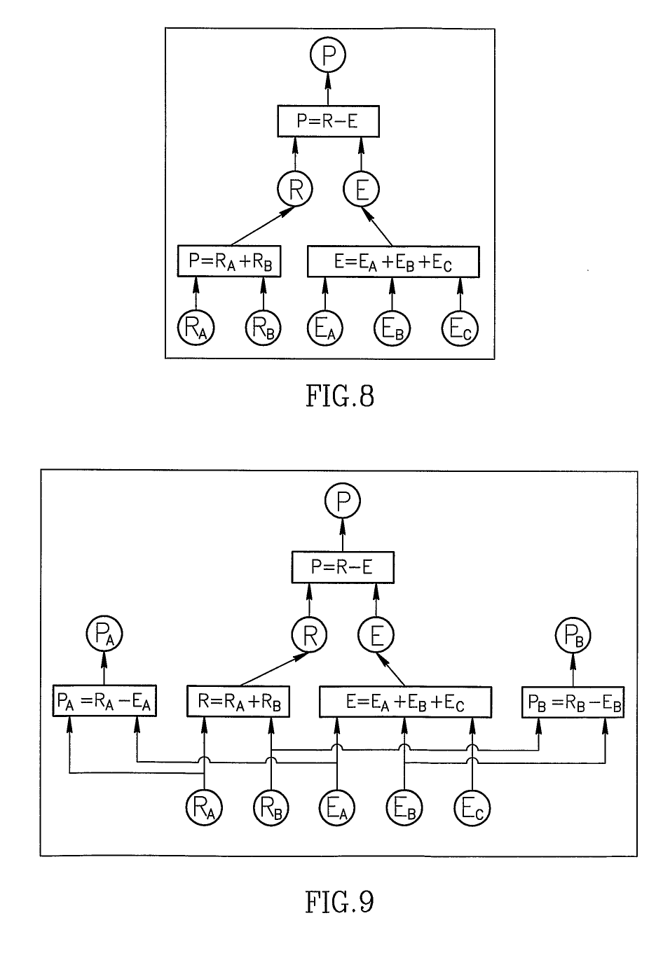

This equation should be regarded as a constraint, rather than a directed formula. These constraints form a set of equations, and may be described graphically, as shown in FIG. 8.

In these simplified examples, the constraint diagrams are simple to draw and understand. This is not necessarily the case when a complete organizational scheme is represented, since there might be too many constraints with too many interconnections, which might make it impossible to comprehend visually.

In our example, the manager of the company may be mostly interested in the total profit, the top node marked P; the value of P will be available as part of the cockpit (visual representation to be described below. The managers of the different business units (BU's), however, are not directly interested in P, because they do not own it. Rather, the manager of BU A is interested in P_{A} and the manager of BU B is interested in P_{B}. FIG. 9 illustrates how this information is added to the system.

Unit C may be different since, for example, if it only creates expenses and not revenues for the organization, such as the BU responsible for the supply chain. The manager of this unit is, thus, not measured by a profit indicator, but rather by another indicator of the system, called PT (percentage of turnover). This unit is measured, in this case, by:

$$PT = \frac{{E}_{A}}{E}$$

More generally, if unit C's expenses are comprised of K expenses E₁ . . . E_{K}, the constraint would be:

$$PT = {\sum }_{i = 1 … K} {E}_{i} / E$$

The power of constraint propagation may be appreciated when it is considered that typically, the whole organization comprises a single, huge network. This occurs because even the seemingly unrelated parameters eventually contribute, for example, to the organization's profit line. This means that seemingly insignificant changes in obscure parameters may trigger chain reactions that propagate throughout the organization, which may be of highly important consequences.

Another important point about constraint propagation is that it can be activated in different directions: in normal mode data is typically propagated “upwards”: from raw data “up” to the major key performance indicators (KPIs) in the organization. However, the network may also be used to propagate constraints downwards. That is, managers may set the desired value for some high-level parameter, and use the network to realize what other changes need to be made in the organization to satisfy this desired constraint. These issues will be described in greater detail hereinbelow.

### States

Parameters in a scheme may be divided into two groups: external and internal. External parameters are connected to sources outside the scheme, while internal parameters are derived, by formulae, from a combination of other parameters, either external or internal. Typically, the key-performance indicators (KPIs) would be internal parameters.

Whenever an external parameter changes, a constraint propagation process is initiated; this updates internal parameters. The propagation may be spread across different parts of the scheme.

During the propagation, the scheme might be in an inconsistent state of affairs. For example, a constraint specifies P=R−E. Assume at a given time R has changed, but the constraint has not yet been re-computed, P has not yet been assigned a new value, and the formulae behind the constraint does not hold. As long as there are such inconsistencies, the system may be described as being “between states”. Only when all constraints are satisfied, and there are no more constraints to be re-evaluated, may the system be deemed as “stable”, and a transition to the next state will have occurred.

Formally, a state is defined: <t,P> where t is the state time and P gives the value for each parameter. The states may be logged in a database in communication with the system for future reference and analysis.

Constraint propagation is known. The present invention includes a proprietary solution for applying constraint propagation efficiently, in a distributed network. For handling distribution, the engine associated with the present invention may automatically segment the network into sub-networks, such that the propagation takes place in many sub-networks in parallel.

### Schema Modes and Snapshots

The Organization Core Schema (OCS) represents the structure of data flow in the organization. An instance of OCS with embedded data is called a “snapshot”. The system may support simultaneous usage of several OCS and snapshots to enable the following operational modes:

Real-time organization monitoring (live snapshot).
Planning the organization goals and objectives.
Historical view of snapshot at a give points in time.
Historical what if simulation of snapshot at a give points in time.
Planning and decisions support by performing simulations based on live snapshot.
Training sessions based on predefined scenarios.

Therefore, when the OCS is created or modified, the system will enable is creator to define the OCS elements for every desired mode. The following modes are available:
Real-Time Organization Monitoring
Planning Organizational Objectives
Historical Snapshot View
Historical What-If Simulation of Snapshot
Decision Support and Simulation
Training

### Financial Concepts in the Scheme

### Comparing Actual and Projected Data

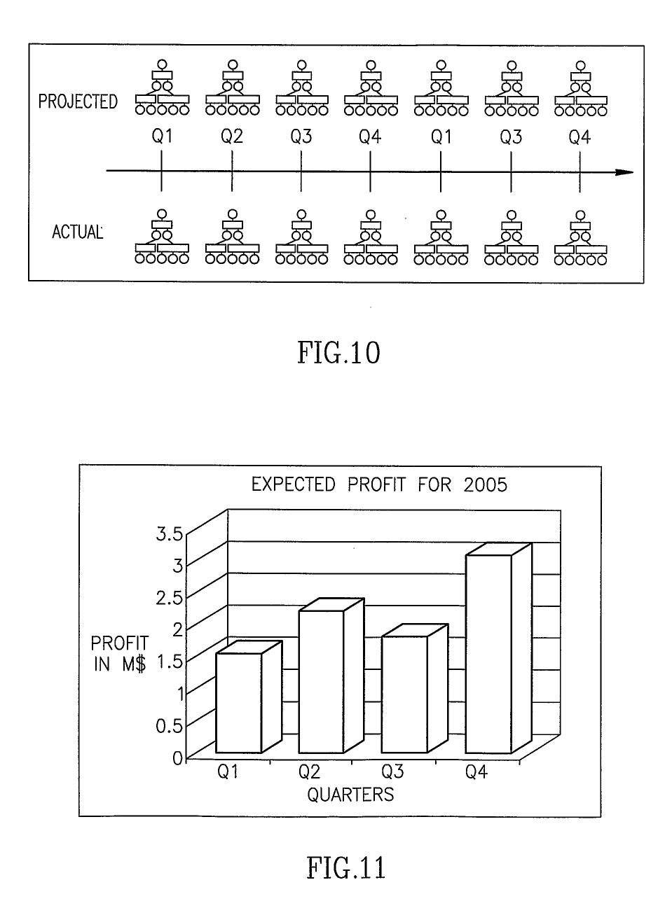

At any moment there are two copies of a scheme for a company: one represents the projected values, as given by the business plan (BP), and the other includes the actual values for a specific duration. FIG. 10 is a schematic graphical illustration showing the projected versus actual values representing an organization's performance, over seven quarters,

An alternative way to understand this is to think of two schemes, where each variable in the schemes is actually a series of values, rather than a single value. In the projected scheme each variable has a series of values as projected for the whole year in the business plan, for example. In the actual scheme, at any given point in time t, for each variable there is a series of actual values observed from time 0 to time t, and possibly a series of extrapolated values from t+1 to the end of the year.

It should be noted that this may be further complicated by the fact that there are natural deviations from a BP during its execution. For the sake of clarity this problem is ignored and the assumption made that the BP is fixed. Natural deviations are described below with reference to “rolling forecasts”.

Assuming that the business plan includes the forecast for 2005 profit as described in FIG. 11. P in the expected scheme is actually the series of values (1.5, 2.2, 1.7, 3.1); which are the target profits for the four quarters shown.

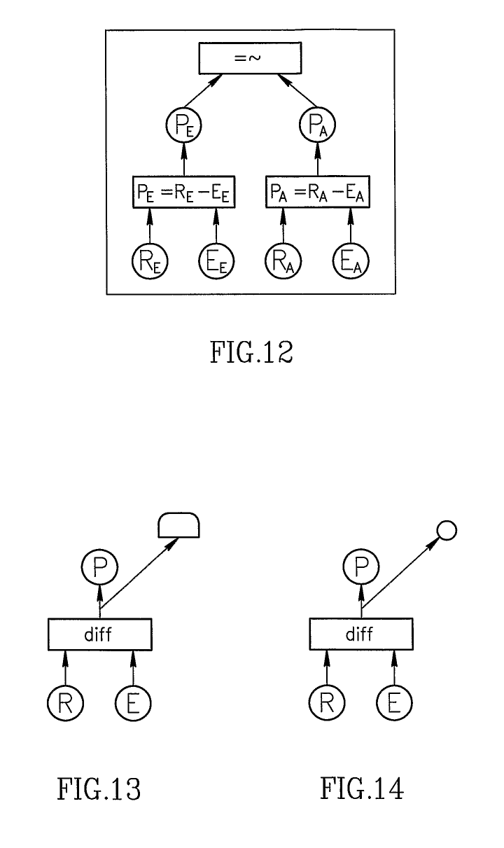

FIG. 12 illustrates an equality constraint specifying that the actual profit must be approximately equal to the expected profit. The subscripts stand for expected (E, the left hand side) and actual (A, the right hand side) profits.

The constraint is marked =˜, or approximately equal.

As we will be described hereinbelow, this constraint may be attached to an alarm, which is activated if the difference between the expected and actual profit exceeds some pre-determined threshold. The threshold may be absolute or relative. The exemplary constraint below specifies that the difference should not exceed 2%:

|P_{E}−P_{A}|<P_{E}·0.02

Using this constraint, there is no difference whether the actual profit is slightly higher or slightly lower than the expected profit. It should be noted that since this constraint has an inequality sign, it can no longer specify precisely what the values should be, since propagation “downwards” is no longer deterministic. This type of propagation is discussed further hereinbelow

This constraint may be referred to as =˜(x,y). If the error should be defined as a parameter of the constraint, the constraint ˜=(x,y,□) may be defined as follows:

|x−y|<□

It should be noted that if the difference between the actual and projected values is interesting by itself, we can split this constraint into two constraints:

d=x−y, and |d|<□.

In this case the difference, denoted by d, may be used in other constraints.

For example, examining the situation at the end of Q1 and assuming that the actual profit in Q1 is $1.49M. The difference between the expected profit, $1.5M, and the actual profit is $0.01 M, which is less than 2% of $1.5M. Thus, the alarm will not be triggered in this quarter. However, assuming that in Q2 the actual profit is $2M. This is almost 10% lower than the $2.2M expected for this quarter, so in this case, by the end of Q2, the alarm attached to the ˜=constraint will be triggered. Alarms will be discussed in further detail hereinbelow.

### Rolling Forecasts

In the example, a simple model has been used, wherein there is a theoretical desired business plan (BP) on the one hand, and the day-to-day execution results on the other hand. In most organizations, it is somewhat more complex.

The BP is typically planned for a year in advance, and sometimes for longer periods of time. While the organization tries to comply with this BP, some real-world constraints force occasional adjustment of the plan. This is typically known as a “rolling forecast”. For example, the sales unit can find out, in the middle of the second quarter that their projections for the third quarter need to be slightly adjusted. This change is then applied to the rolling forecast. Generally, the initial rolling forecast is derived from the BP. During the course of the year (or the duration for which the BP holds), it is occasionally updated.

The present invention engine handles this as follows, by referring to the BP (described hereinabove), as the “rolling forecast”. The values in this predicted-values scheme can actually be modified at any time. These changes should preferably be made, by users with the appropriate privileges, as discussed below.

When such values are changed to the rolling forecast scheme they may cause a new propagation of changes. This is treated like any other change in a value since it is external to the scheme of the present invention. It may be considered to be similar to a new value extracted from a database.

Each time there is a change to the rolling forecast, a version of the rolling forecast scheme is stored for later analysis. The first instance that is saved is the original BP.

It should be noted however, that any computation that takes place in the engine of the present invention is always against the most recent rolling forecast, rather than against the original BP.

It should also be noted that for each parameter participating in the scheme which has a counterpart in the rolling forecast, the rolling forecast counterpart is a series of numbers. This series includes the expected values from the beginning of that forecast to the end of the BP period. Thus, formally, each rolling forecast is a structure:

<t1,S>

where t1 is the beginning of the forecast. It may be assumed that all forecasts end in the same time, which is the end of the BP period. S is a set of functions, or value series, for all the parameters, as explained below.

It should be noted that a series of rolling forecast, R₁, R₂, . . . Rₖ. are accumulated. This series of forecasts maintains the inequality:

t₁(R₁)<t₁(R₂)< . . . <t₁(Rₖ)

It may be possible at a later stage to analyze how the series behaves and investigate the drift from the original BP, which is R₁, during the year.

### Money Surfaces

Often a company is interested in the accumulated differences, or money surfaces; such as “how much money is missing?, for example.

Assuming that the organization is sampled every quarter, then by the end of Q2 the company may be interested in the accumulated difference in profit.

If we denote the expected profit in Qᵢ (i=1 ,2, 3 or 4) by P_{E,i} and the actual profit in Qᵢ by P_{A,i}, then the difference in Q2 is:

d=P_{E,2}−P_{A,2}

However, the company may be interested in the accumulated difference over the year, in which case:

d=(P_{E,1}+P_{E,2})−(P_{A,1}+P_{A,2})

Generally, of course, a company will not be limited to quarters, but will be interested in finer resolutions such as months, weeks, days, or even hours. In any case the accumulated difference will be given by integrals, or, since we are dealing with discrete time series, sums over time:

$$d = {\sum }_{i = 0 … t} {P}_{E , i} - {\sum }_{i = 0 … t} {P}_{A , i}$$

Note that such computations of sums will very often need to convert between parameters given in different time resolutions; this is taken care of by the built-in temporal conversion provided by the engine of the present invention.

Conversions into Money Surface

It is a feature of the present invention that every user is able to see his or her financial impact on the organization. Thus, any KPI in the scheme may need to be converted to reflect money surfaces. Some KPIs are given in dollars; for them, it is enough to show the accumulated values (integrals), which represent the money surface. Other KPIs may be denominated in completely different units, such as the PT (percentage of turnover) indicator. indicator described hereinabove.

The measurement unit for this parameter may be denominated is “percentages”. In order to convert it into money surface, it may be necessary to look at the difference in percentage between the actual and expected values, for our current time frame of interest.

For example, assume that a BU had to achieve 6% PT and instead it is currently expected to achieve 7.5% PT by the end of the quarter. The result is that the BU might diverge in 1.5% for this quarter. The monetary impact is simply 1.5% of the turnover. So in order to convert a PT into a money surface, a constraint should be installed:

M=(PT_{E}−PT_{A})·R

Where R is the turnover (revenue). The user interface (UI) may decide to show the PT, its monetary translation M, or both. It should be noted that if the expected PT is larger than the actual PT, the organization has gained money, whereas if it is smaller than this is a negative amount (equal to lost money).

The user may want to look at accumulated PT rather than at a PT value in a certain point in time. If the system would take the accumulated PT over time and then convert it into a monetary unit, it will only be approximating the money surface. An accurate computation requires recursively traversing down the formulae tree until the parameters of the monetary units are reached. In this case, it is necessary to look at accumulated expenses when computing the PT:

$$M = ( \frac{{\sum }_{{E}_{EA}}}{{\sum }_{E}} - \frac{{\sum }_{{E}_{AA}}}{{\sum }_{E}} ) \cdot \sum R$$

where E_{EA} is the expected expenses of unit A, E_{AA} is the actual expenses of the unit, and the sums all run over the same time period.

### User Interface

Reference is now made to the basic user interface (UI) elements, which describe how a user may interact with a scheme. FIGS. 13 and 14 illustrate exemplary user interfaces from a functional point of view, in order to explain how they are connected to the scheme.

### Dials

Dials provide a quick view of the key parameters. They are divided into three regions:

1) Red: requires immediate attention

2) Yellow: requires further investigation and possible actions

3) Green: this parameter is ok, have a nice day.

The hand is positioned on the dial according to its accurate value, and this would always be on the red, yellow, or green. Formally, it is defined by: <a,b,c,d>, where the value of the parameter can vary between a and d, red is between a and b, yellow between b and c, and green is between c and d.

The dial is attached to a parameter in the scheme, as shown in FIG. 13.

If the dial is in the red zone, the user needs to able to see where the trouble is with one click. Regardless of how this is implemented in terms of UI, the engine needs to provide the logical link. This is identical to the way alarms are tracked; as will now be described.

### Alarms

Alarms, like dials, are generated automatically for each parameter. These alarms will be triggered if the parameters reach some pre-defined (significant) range of values. Alarms may signal either risks or opportunities, that is they may signal that a value is in both extremes of its range.

Since the actual value v always satisfies the following:

A≦v≦B

Alarms are defined by a set: <P,C,D>. Where P is the parameter attached to the set, C and D specify a sub-range [C, D] of the range [A, B] may be defined to trigger an alarm. C and D satisfy the equation:

A≦C<D≦B

The range is normally extreme, i.e., either C=A or D=B.

Alarms appear visually on the cockpit associated with the present invention, and may also be sent by electronic mail or Short Messages Service (SMS).

In the example of FIG. 13, alarms are shown attached to a profit parameter.

When an alarm is on, the users need to be able to easily understand the problem. This may be done by allowing them to follow the constraint scheme step by step, in which each step highlighting the problematic elements.

For example, assume that the profit R_{B} in unit B is too low, and this causes a top-level alarm for the organizational profit P. Then the following information should be made available to the user, according to the following order:

P is too low (should have been P′)

R is too low (should have been R′)

R_{B} is too low (should have been R_{B}′).

For this information to be provided by the system, the expected values (P′, R′, R_{B}′) need to be available in the scheme. If they are not available, the system cannot guess where the problem is; it can only suggest the values comprising the offending parameter. For example, if R_{B}′ is not given, then the system can only point to the formula R=R_{A}+R_{B}+ . . . .

If all target (expected) values are given to all participating parameters, the system needs to decide which parameter is the one that is causing the problem. Assume that the expected values for P, R, and E, in the formula P=R−E are, respectively: 50, 80, and 30. Now assume that the actual values are, respectively: 40, 70, and 30. In this simplified example, R is the only one in which there is a difference, so it is clearly responsible for the problem.

But what if the values are, respectively: 40, 65, and 25?

The following approach may be taken. For each participating parameter X, assume X_{E} is the expected value and X_{A} is the actual value. We look at the percentage of error, E:

$$PE ( X ) = \frac{\vert {X}_{E} - {X}_{A} \vert}{{X}_{E}}$$

If PE(X) is higher than some value ε, then it may be decided that X is responsible for the error. The value of ε can be constant throughout the engine, or can be defined per parameter. It could be defined, by default, to be equal to the error-tolerance parameter that sets an alarm for that parameter, if such is defined. It may be desired to allow the user to override this value.

It is possible that more than one parameter is responsible for a problem; in this case all the information needs to be displayed to the user as part of the explanation.

### Time Sliders

At any moment and in every context, Friend allows the user to traverse the timeline backwards (to the past) or forward (to the future). The user can set the resolution of the timeline. If the user chooses to scroll back in time the system updates the current view to display the values of the parameters as they were in that time point in the past, as saved by state snapshots (Section 0). If the user chooses to scroll to the future, the current view is updated to show the predicted values of the parameters currently in view, as computed by the Friend engine prediction modules. Note that past views may also require computations; for example, if the current parameters do not contain a data point in the particular time selected by the user, the value estimated for that time is computed using interpolation.

### Constructing a New Scheme

In order to define a new scheme from scratch, the user needs to define collectors (data sources), parameters, and the formulae that connect the parameters. In an embodiment of the present invention, a set of user interface (UI) wizards are provided for completing these definitions. Using these wizards the user may set the options and select parameters and formulae from pull-down menus. The UI is built automatically, as it is a reflection of the scheme structure. Tools may also be provided for users to customize the UI and override many default decisions made by the system.

As described above, the scheme may include the atomic building blocks of the present invention. In addition, a scripting language, which allows for defining new building blocks may be also included. These building blocks, called “procedures”, are equivalent to formulae, and may serve as constraints. They may contain within them several constraints and parameters, including temporary parameters that only exist during computation.

The syntax of the scripting language allows referring to all of the capabilities of the present invention, such as parameters, properties, temporal resolution and transformations, UI elements, for example. The scripting language is a powerful tool which enables a user to extend the capabilities of the engine. Once a new procedure exists, it is easy to wrap it with a UI wizard, making it easy for end users to use. In fact, all the wizards provided by the present invention are built on top of the scripting language. As will be appreciated by persons knowledgeable in the art, the procedure language may be defined as required.

### Template Schemes

A set of template schemes may be provided. Thus, when a new customer wants to use the system of the present invention, he can select the template scheme that is most similar to his organization and adapt it to his organization.

### Modifying the Scheme

One of the most powerful features of the present invention is that the scheme may be easily modified, in contrast to other methods, such as OLAP, where every change might require re-implementation which may take several months. Thus, with the present invention, whenever there is a structural or functional change in the organization, or whenever there is new insight regarding KPIs, the scheme may be modified quickly, usually within in a matter of hours. The scheme may be modified using tools to traverse the scheme structure, and UI wizards to redefine formulae and parameters. These wizards also protect users from carrying out illegal changes, such as deleting a parameter that is still referred by some formula.

It should be noted that, owing to the flexibility of the collectors, many changes in the organization are automatically reflected in the method of the present invention, without a need to take any action. Thus, whenever there is a new property-value, such as a new product, material, customer, for example, they are automatically updated in all the corresponding parameters.

### Exploring the Scheme

The user interface is a reflection of the scheme structure and thus, users may extract useful information by ‘exploring’ or ‘traversing’ the scheme structure.

The engine maintains a list U of users of the system in the organization. In addition, there is a list V of UI elements, such as dials and alarms. These correspond exactly to the list K of key performance indicators (KPIs) (parameters).

The method may be described as follows:

First, the top page for each user is defined. For each user uεU there is a set T⊂V of UI elements that the user sees in his/her top page. Also, for each user there is a set K of KPIs that the user owns. The UI elements a user sees in his top page are always owned by him. Formally, the set T is always a subset of K, T⊂K. Possibly, the user owns a lot of KPIs, and then they are not all displayed in the top page.

From the set T, the user may wish to drill-down. The user should be able to drill down an unlimited number of levels, until he reaches the organization's DBs that are external to the system.

Example: The manager of our P&L unit M first sees four dials, corresponding to four parameters:

1) S—total sales

2) F—finance control to P&L

3) SoT—% of supply on time

4) PSvI—predicted sales vs. inventory

For each of these parameters there is also an alarm, which is either on or off. It should be noted that these four KPIs are all internal parameters, whose values are generated by formulae inside the engine.

The manager can now drill down to explore each of these parameters in more detail. This browsing is based on the scheme. Assuming that the manager wants to drill down into the sales parameter, the sales parameter S is a result of one or more formulae, such as:

S=ΣSᵢ (i goes over all departments)

Each element Sᵢ is the total sales for department i. Thus, when clicking the link from the parameter S, the next page will display S and all the participating parameters; in this case, the page will show the total sales for all departments.

It should be noted that that each formula is of the type y=f(x₁, . . . , xₖ). “y” is the output of the formula and each of the xr is an input. Each formula may be displayed in one page, and the formula structure may be reflected in the Ul design. For example, the output can be larger and on the top half of the page and the inputs can be lower on the bottom of the page.

For each of these parameters, a UI element, and any alerts that may be attached to, may be shown.

Each parameter may be displayed in one of two types of UI elements; dials and sliders. For each parameter there is an attribute that specifies its display option. Furthermore, each parameter is displayed by its name, which is kept as another attribute for each parameter.

### Users, Authentication, and Security

Authentication is based on the organization scheme structure. That is, each user may be assigned two subsets of the scheme; one where the user has permissions to change values, and one that is read-only. Typically, the first is contained in the latter.

In addition, each user may have his own UI settings; that is definitions that link the entry page of that user into the scheme.

### System Architecture

As will be appreciated by persons knowledgeable in the art, there are many alternative architectures, which may be utilized with the system of the present invention. An exemplary architecture of the present invention is now presented:

### Distributed Organization Schema

Preferably, the system should support distributed organization schema that will be located in many locations to support organization branching. This requirement may be accomplished by allowing the various schema to operate across network connections. The distributed organization schema will enable remote branches to use the local portion of the organization schema while headquarters can view a wider picture of the organization performance, for example.

### System Modules

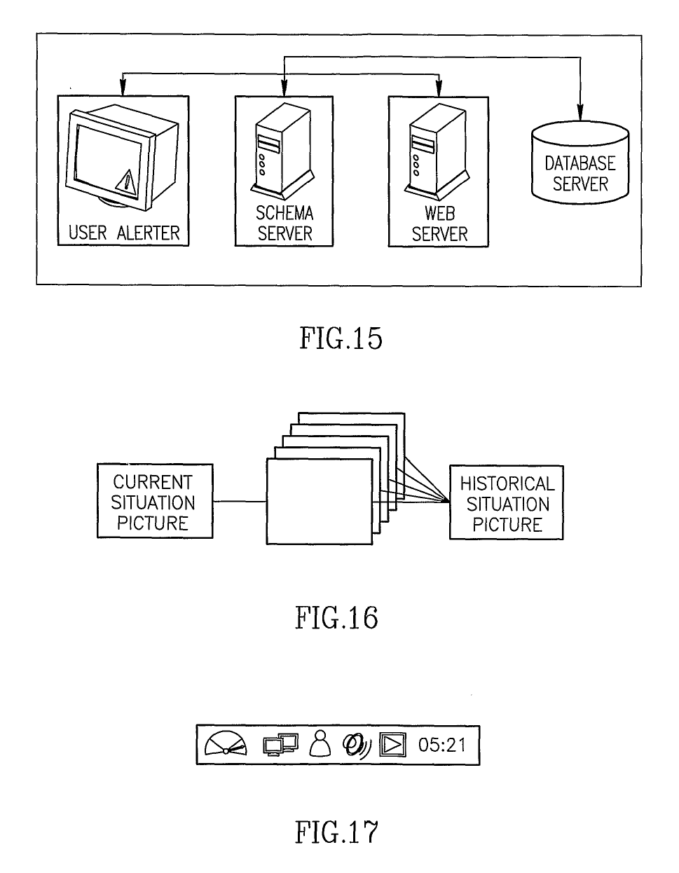

The present invention comprises four types of applications that may perform all the system activities. The applications include schema server, user alerter, web-server and database server. FIG. 15 shows the system modules and their connectivity.

### Database Server

The database server may be a standard, off the shelf RDBMS database, that will provide storage for organization schema, data snapshots, alerts and system configurations, for example. The snapshots in the database will be updated automatically when new data arrives, periodically a new snapshot will be created to enable historical views. FIG. 16 is a schematic illustration of a history stack.

### Schema Server

The schema server is the brain of the system, its purpose is to sustain and execute snapshots. On startup, the schema server reads organization schema and snapshot from database into its memory and creates in memory all containers, connectors, formulas and collectors. When the initialization is carried out, the server starts monitoring the collectors that initiate the snapshot updates using the connections and formulae.

The schema server may support running in several instances to allow distributed schemas or large organization schemas.

### Web-Server

The web server may be used to produce HTML pages that enable the user to use the system. The web server may comprise three sub web sites, for example, each for a different type of activity. An exemplary list of the web sites and their major activities may include:
The main site—This site will provide the common daily activities for regular users. The source of information used by this web site will be pulled directly from the schema server memory. Activities supported by this site include: viewing the live snapshot, planning organization objectives and decisions support, viewing historical snapshots, historical what if, simulation and training.
Schema Administration—This site will serve the system finance professionals that define and maintain the organization core schema. Users of this site will be able to: define CICs CSCs CSFFs CIRs CFAs, write formulas scripts, write collectors scripts, define new schemas and schemas modes.
System Configuration and Maintenance—This site is addresses the IT professionals that keeps the system running. This site will provide: starting and stopping the schema server for backups, setting system access privileges, removing unneeded data snapshots from database, configuring system parameters and viewing system faults logs.

### User Alerter

The system further includes a “user alerter”, which is a small program that is running on the user workstation alerting the user to take actions in cases when organization objectives may be affected. The alerter may be implemented as system tray icon, shown in FIG. 17, providing the users with a constant display of their accomplishment in comparison with their objectives. Clicking on the tray icon will open the user's objective monitoring web page. In case the system needs to alert the user, the user alerter will open a popup window informing the user of what went wrong.

### System Interfaces

The system may have several interfaces including a user interface, database interface and communication interface, for example

### User Interfaces

The user interface may be developed using known web technologies. The pages produced by the systems main web site may be optimized to be used on any user platform such as regular home/office PCs, laptops computers, tablet computers, PDA, handheld PC and mobile phones, for example. The system may optimize content and pages functionality according to the user browser capacities while maintaining global standards.

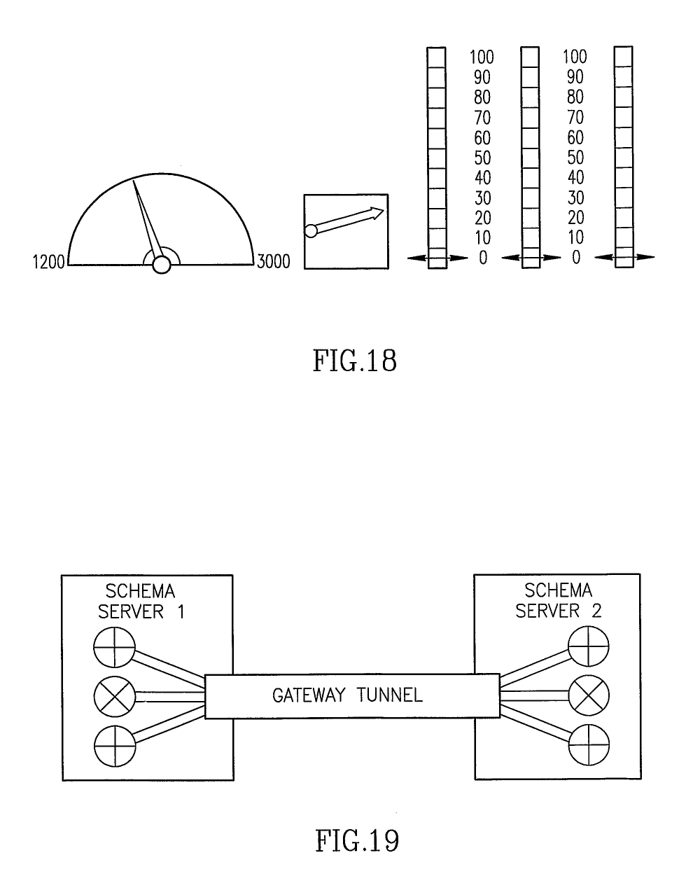

Reference is now made to FIG. 18, which is schematic representation of various indicator gauges for use with the system of the present invention.

Organization monitoring and reporting pages may be designed to be quickly and easy to comprehend using “dashboard gauges” that indicate the organizational financial state relative to organization business objectives.

When a gauge indicates green it means that business objectives are met, a red indicating gauge means business objectives are not met and immediate action is needed. In addition to the main status gauge, two other gauges may be used to clarify the picture; a trend gauge that will provide the direction of changes and volume indicators that show the amount of CIC elements found below the observed CIC in each status.

When desired the user will be able to access gauges data in graphs or table reports using a single mouse click on the appropriate gauge.

The administration and maintenance web sites are designed to perform more complex tasks and may require fully enhanced web browsers running on the user work station.

### Database Interfaces

Fast databases access is critical for the schema server, since slow database access may harm the ability to access large organizations input data or to update the organization snapshot. Therefore database access will preferably be implemented by internal database interface layer that may use the database provider direct APIs, this approach will be used for the most popular databases on market like Oracle or MS-SQL server, for example. For less popular databases, the database interface layer will external libraries such as ODBC or ADO, for example, this will enable the system to access many types of databases while keeping the system high performance.

### Collectors—Data Input

Data collectors are the system's way to access organizations data sources. Input data may be collected from wide range of input sources. The system may use several implementations of data collectors, each of which may support a different type of input data source. All collectors' implementations will implement a common collector interface, thus making the usage of collectors transport to the Organization Core Schema (OCS). The system may support various input data sources, such as:
RDBMS using SQL queries
OLAP queries/cubes
ODBC data sources
XML files
Web pages
Microsoft Excel work sheets
Formatted text files
Manual user input via HTML pages
Web services

The process of defining a collector in the organization will enable the user to specify the type of collector to use and will guide the user to specify all needed parameters that are required to use the collector.

### Communications Interfaces

As previously mentioned hereinabove, the system must operate as a distributed system enabling all system components accessing other system components across the network. When looking at our system model it appears that the system will use many network connections that may require large number of network resources. This problem may be eliminated by using smart network tunneling between systems servers where many system elements share single network connection as shown in FIG. 19.

All tunnels may be based on TCP/IP communication. When schema server starts it may establish a tunnel connection with the rest of schema servers in the system allowing every object to communicate with any other object in the system using the objects unique id only (messages sent via the network will include the originator and destination unique id).

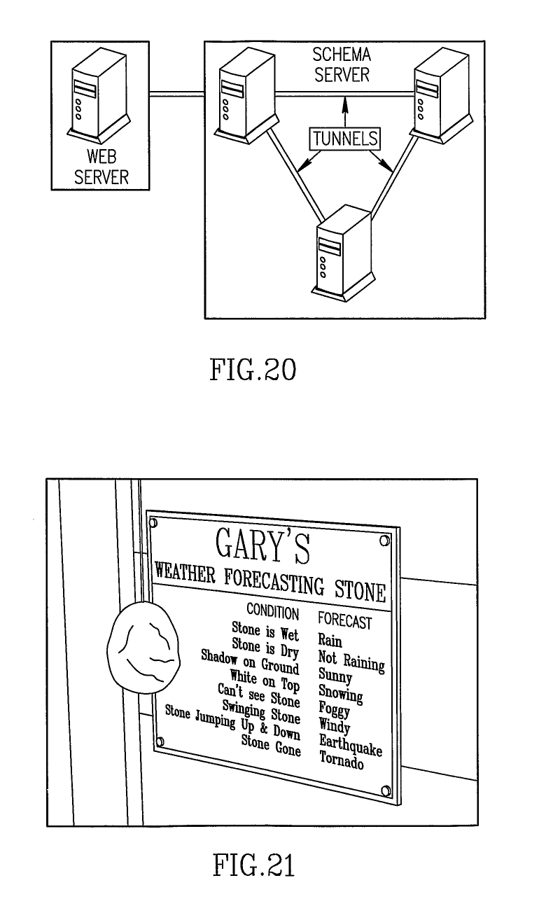

In order for other modules (for example the web server) to access any object in the business schema the module may connect the nearby schema server (using TCP/IP) that will route the module commands using his tunnels. A representation of a schema servers network is schematically illustrated in FIG. 20.

### Forecasting

Most large organizations have their preferred methods for trying to predict some of the parameters critical for them. FIG. 21 illustrates an example of a forecasting method that has proven to be effective.

The present invention is capable of leveraging existing forecasting methods since the system of the invention contains an overview of how the different parameters related to the organization are inter-connected.

In a typical scenario, there are two main approaches to forecasting:
1) Explanatory method: The estimate of future values is based on an analysis of factors that are believed to influence these future values.
2) Extrapolation: prediction is based on an analysis of past data behaviour over time.

A further feature of the present invention is the use of third method can be very useful when combined with the previous methods:
3) Future-based extrapolation: where prediction is based on partial information about future values that is already known at the time of forecast.

The difference between future-based extrapolation and the explanatory method (1 above) is that it relies on data that is already collected with 100% certainty (such as orders for a product), whereas the first method typically focuses on estimates. The difference between future-based extrapolation and the second method (extrapolation) is that future-based extrapolation takes into account partial data about the future, whereas the extrapolation ignores this useful data.

Each parameter of the system generates a time series of values. Since the time series are typically highly auto-correlated rather than random, it is possible to predict future values. This means that there is a high correlation between different lags of the time series.

Before considering various prediction techniques, it is important to note that all predictions are guesses. Thus, each technique, in addition to providing predictions about future values, must also provide a level of certainty.

The forecast error at time t may be represented by:

e(t)=x(t)−f(t),

where x(t) is the forecast and f(t) is the actual value. For example, error estimation using MAD (Mean Absolute Deviation) provides the value:

MAD=Σ|e(t)|/n where n is the length of the series

There are many additional measures to assess the performance (or certainty) of the forecast. They are based on comparing the forecasted values with the actual values for a part of the time series. The “rule of thumb” is to use 20% of the data available for validation.

The present invention, which supports prediction using these three methods, may be described as follows:

### Extrapolation

It should be noted that extrapolation is rarely carried out in a completely automatic fashion; typically, manual intervention is required to inspect and “clean” the data from errors, and experts need to examine the data and fit the best statistical method for the data. Since the present invention works in real-time, manual intervention steps may only be undertaken when setting up the system, or as occasional updates.

### Regression

The most basic extrapolation method is probably regression, and specifically linear regression. Regression analysis is not only used for prediction, but also for modeling, and characterization.

In linear regression a straight line that provides the minimum error is sought. A straight line is given by:

y=at+b

a and b may be found, as follows:

$$b = \frac{SP}{{SS}_{t}}$$

$$a = \hat{y} - b \hat{t}$$

SP, SSₜ, and SS_{y} may be defined as follows:

$$SP = \sum ( t - \hat{t} ) ( y - \hat{y} ) = \frac{\sum t \cdot y - \sum t \cdot \sum y}{N}$$

$${SS}_{t} = \sum {( t - t )}^{2} = \frac{\sum {t}^{2} - {( \sum t )}^{2}}{N}$$

$${SS}_{y} = \sum {( y - \hat{y} )}^{2} = \frac{\sum {y}^{2} - {( \sum y )}^{2}}{N}$$

The amount of error is proportional to 1−r² where

$${r}^{2} = \frac{{SP}^{2}}{{SS}_{t} \cdot {SS}_{y}}$$

This gives an error of the prediction by the regression. If it is 0 then there is a perfect prediction, 1 indicates that the prediction useless.

An alternative method is to look at the standard error of estimate—the standard deviation of the points from the predicted line, given by:

$$\sqrt{\frac{1 - {r}^{2} \cdot {SS}_{y}}{N - 2}}$$

The above formulae detail simple linear regression that is, using one explanatory parameter and approximating the values to a straight line (linear).

As will be appreciated by persons knowledgeable in the art, non-linear regression (e.g., approximating to polynomial functions) may be used. Regression techniques which are much more complex, include generalized additive models, multivariate adaptive regression splines, and regression trees, for example. These techniques are more flexible as they have the advantage that you do not specify a functional form in advance.

### Seasonal Analysis

It is typically worthwhile to try to detect seasonal effects on parameters automatically. A season may be defined as any period of time such as a week, a month, or a quarter, for example. For each such season:

Sᵢ=Dᵢ/D

Where Sᵢ—seasonal index for period I; Dᵢ=average values in period I; D=grand average

For example, a seasonal index of 1 means there is no effect for the season, whereas an index of 0.8 means it is a “weak season”.

Seasonal indices can then be part of the prediction process, as explained below.

### Decomposition Analysis

It may be assumed that the time series of a parameter is a result of the following factors: seasonality, trend, cycling, and irregularity. Or formally:

Xₜ=Sₜ·Tₜ·Cₜ·Iₜ

The decomposition involves the following steps:

1. Trend removal using regression

2. Seasonal removing using smoothing

3. Cycling removal using % ratio

The third step is mostly important for long term prediction, and is fairly complex, so for the purposes of clarity and simplicity has been ignored here.

Now prediction can be made as follows:

1) Compute the future trend using the trend equation

2) Adjust for seasonality

3) Adjust by the cyclic effect (Friend ignores this step)

### Smoothing

An alternative approach for prediction is called smoothing. Smoothing actually removes noise, but it can be used for short term prediction as well. Several simple smoothing techniques are now described.

### Moving Average

MAₜ₊₁=[Dₜ+Dₜ₋₁+ . . . +Dₜ₋ₙ₊₁]/n

n is the number of observations used.

### Weighted MA

WMA(n)=w₁Dₜ+w₂Dₜ₋₁+ . . . +WₙDₜ₋ₙ₊₁

A typical weight would be

Wᵢ=n−i+1/(1+2+ . . . +n)

### Single Exponential Smoothing (SES)

Fₜ₊₁=αDₜ+(1−α)Fₜ

Fₜ is the forecasted value, and α is a weighting factor between 0 and 1.

Sometimes we want double or even triple exponential smoothing: applying smoothing two or three times to the same series.

SES requires stationarity, double SES can capture linear trends, and triple can handle almost anything we expect in business time series.

### Exponentially Weighted Moving Average

The weights are:

α(1−α)^{k}

Where k is how many steps back in time we want to look at.

### Holt's Linear Exponential Smoothing

For a series with a trend but no seasonality, we use level:

Lₜ=αDₜ+(1−α)Fₜ

and trend:

Tₜ=β(Lₜ−Lₜ₋₁)+(1−β)Tₜ₋₁

α and β are between 0 and 1.

Forecasting for time k in the future is then:

Fₙ₊ₖ=Lₙ+k·Tₙ

The initialization is as follows:

T₂=D₂−D₁

L₂=D₂

F₃=L₂+T₂

### Additional Smoothing Techniques

If the data includes seasonality, the Holt technique can be extended to the Holt-Winters forecasting technique.

### Example

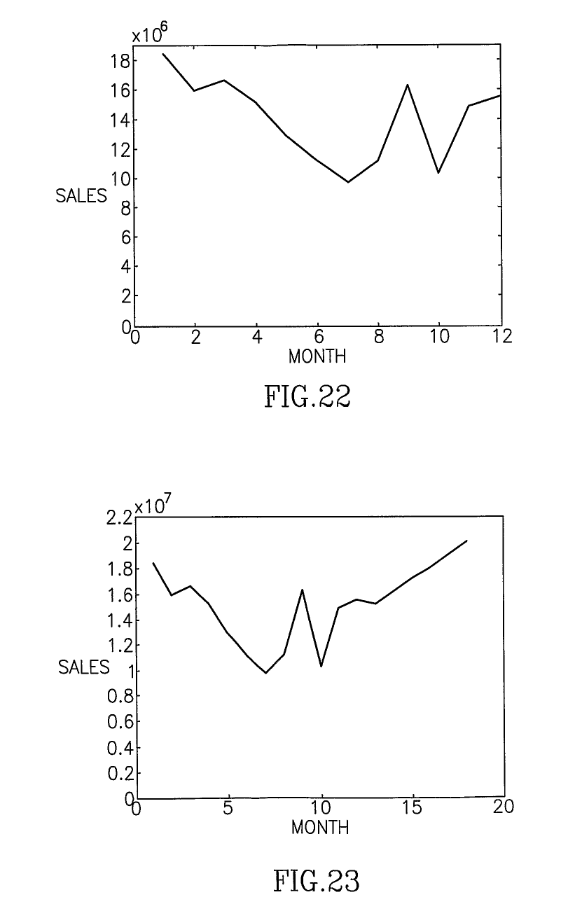

Reference is now made to FIG. 22 which illustrates a row from a monthly table. This row includes sales figures. Note that in this case the number of values is very small (12 values only, one per month). Typically exploratory forecast is only applied when there is much more data.

FIG. 23 illustrates a 6 month prediction using exponential smoothing. As can be seen, simple exponential smoothing assumes a stationary series, that is, it does not take into account trend and seasonality.

As can be seen, analyzing the trend is not sufficient. The forecast, in this case, assigns more weight to recent data, from the end of the year, than to early data from the beginning of the year—this is why the forecast for months 13-18 increases. Furthermore, the forecast is linear, which is not necessarily typical for the data.

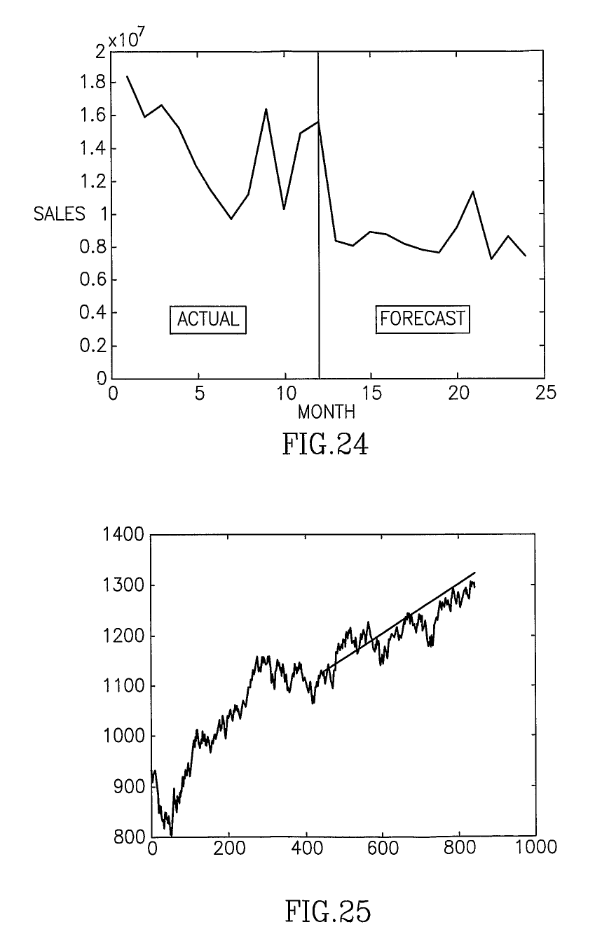

To further improve the forecast, the Holt-Winters method, which takes into account both trend and seasonality, may be used. The result for the same data is shown in FIG. 24, which displays a 24 month forecast. Generally, long term forecasts are avoided, but are useful to show the complete 12-month seasonal trend factor. This forecast is only based on data from a single year; obviously, a typical seasonal analysis will only be meaningful if based on data from multiple years.

FIG. 25 illustrates the trend detection for the S&P500 index from 2003 till the end of March 2006: based on the first half of the year it predicts the second half of the year (shown in by the straight line).

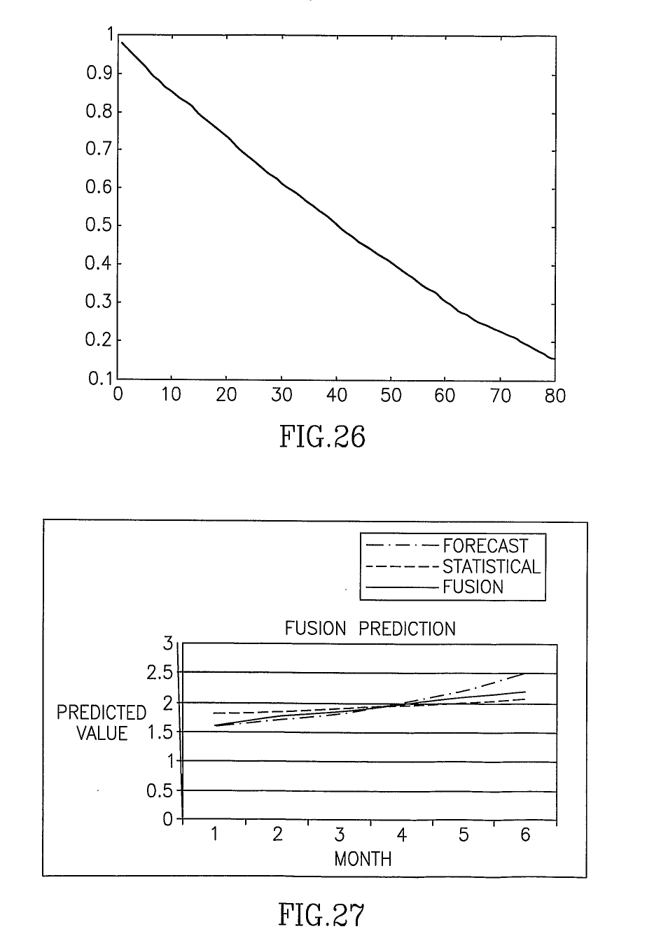

As a measure of confidence for the forecast, the autocorrelation coefficients for the series may be considered. As may be seen in FIG. 26, the auto-correlation coefficients drop quickly to low values.

### Other Prediction Techniques

As will be appreciated by persons knowledgeable in the art, other prediction techniques may also be used.

Smoothing can be considered a simple case of filtering. More advanced techniques include, for example:
Adaptive filtering
Hodrick-Prescott Filter
Kalman Filter
Neural Networks
Probabilistic Models (such as Markov chains)
Box-Jenkins method

It is also possible to use combined techniques, that is to use several techniques to balance each other. The main question is then how to weight the results from each technique.

It should be noted that that prediction typically requires detecting outliers. Outliers are extreme singular values that diverge from the “business as usual” course of events. Smoothing techniques are especially sensitive to outliers, since they are based on averages. Ideally, outliers would be detected and replaced, e.g., by the average of two near values.

### Extrapolation

For each parameter, the user may define his preferred extrapolation method. This can be achieved using a simple wizard, in which the user selects a few parameters from pull-down menus. The present invention provides basic extrapolation techniques and may include basic capabilities for prediction, based on linear regression, smoothing and seasonality analysis. More specialized methods may be available as plugs. Due to the plug-in architecture of the present invention, it may also be possible to add in third party prediction tools.

The present invention also provides an application programming interface (API) that allows extension to arbitrary extrapolation methods. The interface provides the existing time series as input and expected future values and certainly levels as output. Using this interface, the present invention may also provide advanced extrapolation techniques.

### Explanatory Forecast

Business forecast involves assumptions about the future; organizations know quite a lot about the behavior of their parameters, even if they cannot predict them with 100% certainty. Sometimes these are simple rules of thumb that are known to work well and sometimes there are complex mathematical models that capture the behavior of specific domains. For example, there are models for advertising campaigns, estimating production quantities, inventory management, price predictions, for example,

The present invention does not replace these models, but preferably is integrated with them. The simple way to integrate the present invention with such business predictions is by using APIs to external data sources, as previously described. The present invention could use a list of future values as the predicted values for that parameter.

Another method allows for integrating extrapolation and domain-specific business forecasts; such as fusion (described hereinbelow).

A simple example is seasonal indices. As described hereinabove, indices may be derived automatically and then used with trend analysis to obtain a forecast. Similarly, it may be assume that the seasonal analysis is not carried out automatically by the present invention, but may be provided by an external module.

Another example is a marketing campaign. The sales department may provide an estimate of how they believe the campaign will affect a parameter (such as sales of a specific product), and provide this information by a time series of indices.

The business forecasts may be a result of an arbitrarily complex model. The present invention is indifferent to the model, and can leverage on that model as long as it provides a time series of indices, given either in relative or absolute terms.

### Future-Based Forecast

Most of the techniques are standard parts of many solutions, but future-based forecast and fusion are features of the present invention.

The present invention introduces a new kind of prediction. In many cases, partial information about the future behaviour of parameters is available. For example, we do not know the total sales of a certain product over the next few months, but we already have some orders for that product, which have already been made and are already in our system. Such partial information about the future may be very valuable, but it is very often ignored in organizations, and in prediction systems.

In order to use this partial information for prediction, a track of the ratio between the partial information and the actual values, as it behaved in the past needs to be kept. In a simplified version, this ratio is a function RF:

RF:(P,T)−>R

Where P is the parameter, T is the duration we want to predict for, and R is the predicted value. For example, assuming the parameter is the total sales value and it is desired to know the total sales to expect in the following month. Now, suppose the ratio function for parameter p for one month ahead, denoted by RF(p, 30), returns a value of 7.2. It is also observed that the orders for our product for this month, which are already in the system, are in a total of $5M. Thus, the expected sales for this month, based on this prediction, are $36M (5*7.2).

In order to use this prediction a vector of the ratios between partial future information and actual data should be pre-computed. This may be achieved using the present invention by setting an attribute for any parameter for which this vector should be available. The system of the present invention logs information for future predictions, according to the temporal resolution of the parameter, as follows:

Each time t, it looks at the intervals [t,t+1], [t,t+2], . . . , [t,t+k] for some k. For each such interval, it stores the value in a history buffer: h(t,1), . . . , h(t,k). Then, whenever we move to a future time unit t′, the ratio between the actual value recorded, v(t), and the history buffers that we kept in the past: v(t′)/h(t′−1, 1), v(t′)/h(t′−2,2), . . . , v(t′)/h(t′−k,k) are compared. These values then become part of the ratio vectors for the parameter.

Assuming no trend and seasonality, one vector may be computed by averaging all ratio vectors.

If the series is known to contain trend and seasonality these need to be taken into account when computing the average ratio vectors.

Another factor is that the system needs to have enough values before this prediction can become valuable.

Finally, we note that this prediction method can be used as part of a fusion prediction, as explained in section 0.

### Certainty Estimations

For each predicted value, the present invention also may provide a certainty estimation, which is the probability that the actual value will be identical to the estimated value.

### Fusion

Reference is now made to FIG. 27 which illustrates the effects of fusion prediction.

Given a parameter, the user will be able to provide forecast information—this would be integrated with the statistical prediction. It should be noted that the word prediction is used to specify automated computations, versus forecast, which is human information.

There are two types of forecast: relative—which would be applied on top of the statistical prediction, and absolute—where the user wants to override the automated prediction.

These are several ways users may specify relative forecasts:

1. seasonality—users may provide a vector of 12 values—relative index for each month. For example, if they think the sales in June is half of the usual the 6^{th} value will be 0.5, and if they think the sales in April are typically higher by 30% the 3^{rd} value will be 1.3.

2. events—users may predict the effect of marketing campaigns and similar events, and provide vectors of effect. For example, if a campaign is planned for July, the user can add forecast events <7, [1.5, 1.3, 1.1]>. This means that in July we expect 50% increase in this parameter, in August a 30% increase, and in September a 10% increase.

3. trend change—users can predict that at a certain time the trend of a parameter will change. This is also useful for simulation: the user can specify the change in relative terms—as an increase or decrease in current trend. Thus, if the current trend is 1.1 (10% increase per time unit) and the user specifies 20% increase, they expect the trend to be 1.32. if they specify 30% decrease it will be 1.1−0.33=0.77 trend, i.e., the trend will change from an increasing parameter to a decreasing parameter. Users may specify trend change by two values: <start-date, percentage-change>.

Absolute forecasts are just specific values, either <time,value> pairs or pairs of a start time and a vector of values <time, v>. Optionally, the user may provide a level of certainty. If the level of certainty is less than 100%, then the system computes a weighted average of the human forecast and the statistical prediction. The certainty value of the statistical prediction is given with the prediction, based on the autocorrelation of the time series in the past. Automated certainty estimations are vectors; typically the certainty can be high in the short term and very low in the long term. Human forecasts can also have certainty estimations expressed as vectors over time.

For each specific value in the predicted time series, the value is <v,c>—value, and certainty level. Let's say we have a forecast <v1,c1> and a statistical prediction <v2,c2>. Then the weighted prediction v will be:

v=v1*(c1/c1+c2)+v2*(c2/c1+c2)

unless one of the values c1 or c2 is 100—then we select this value. It is illegal to have two different values with certainty 100—this is a contradiction.

As an example, consider the following combination of 6 month forecast and prediction:

TABLE 1
Sample forecast with certainty estimations.

| | Month | | | | | |
|---|---|---|---|---|---|---|
| | 1 | 2 | 3 | 4 | 5 | 6 |
| fore- | 1.6 | 1.7 | 1.8 | 2 | 2.2 | 2.5 |
| cast | | | | | | |
| cer- | 100 | 90 | 80 | 70 | 50 | 25 |
| tain- | | | | | | |
| ty | | | | | | |
| statis- | 1.8 | 1.85 | 1.9 | 1.95 | 2 | 2.05 |
| tical | | | | | | |
| cer- | 88 | 81 | 70 | 64 | 60 | 55 |
| tain- | | | | | | |
| ty | | | | | | |
| Pre- | 1.6 | 1.771053 | 1.846667 | 1.976119 | 2.090909 | 2.190625 |
| dic- | | | | | | |
| tion | | | | | | |

A further feature of the present invention is that by using constraint propagation, it allows managers to set a course for their organizational unit in the future and allows managers to find places within the organization where more money can be earned, or when money can be saved.

### Simulation

One of the most powerful features of the present invention is that it allows sophisticated simulations, which are based on all relevant and up to date data. Simulation takes advantage of the unique constraint propagation model of the present invention.

In normal operation, data is typically fed in one direction: from databases and data sources, through various formulae, “up” to the UI. In simulation mode, the user may replace these sources with alternative, hypothetical values. In addition, data may be fed from the “top”, or the UI, and the computation takes place accordingly.

The user may specify a specific value for any parameter at any time in the future, and observe the effects of this change throughout the organization. The present invention can simulate future behavior by applying the prediction algorithms on all relevant parameters, except for the parameter specified by the user. In all other respects, the system behaves as usual—the different UI elements, such as dials and alarms, reflect the predicted future behavior, based on a combination of prediction (extrapolation) and the specific change requested by the user.

For example, the present invention allow the user to quickly gain a deep understanding of how the organization will be impacted by a sudden change in external parameters such as currency exchange rates, prices of raw materials, etc. As another example, consider that the sales department (or others in top management) can immediately evaluate the effects of changing the price for selected products. The user may drag the time-line into the future and observe the changes in any parameter in the system.

The simulation is based on prediction, and is thus, of course, based on estimations. For each value in the simulation, it provides a certainty value; as discussed with reference to predictions above.

In simulation mode, the user may also specify values of parameters that are not usually inputs to the system, but are computed results. For example, the manager may specify the net revenue for the whole organization in the future to some desired value. The system then simulates all input values, and propagates these values “upwards” in the scheme. When reaching the parameter for the net revenues, the simulated value may be different from the value requested by the manager.

This is where the full power of constraint propagation comes into play. The engine detects this as a contradiction, and tries to remediate the situation using constraint propagation. The value provided by the user is assigned full certainty (100%). Since all the rest of the values are based on extrapolation algorithms, they will all have certainty values less than 100%. The engine will start propagating these values down “down” the scheme.

The propagation in this case is often non-deterministic, i.e., there are many ways that could satisfy the equations. It is expected that the user “drill down” and let the system know which values may be able to change and which values are fixed; this process of interactive constraint propagation allows the user to adjust the course of the organization.

The basic scenario is as follows: at some point after the incorporation of the system into the organization, the manager observes a gap between the projected value of a key parameter and its actual value. The managers can use the system to drill down and find out the causes of the problem. Once they understand the problem, they can also specify for each parameter whether it is fixed or whether it may change. This allows the more flexible values to automatically change and reflect the divergence from the business plan (BP).

As a simple example, consider the simple formula: P=R−E. Assume the profit, P, is too low. The manager sets R to be fixed, so the only way to achieve the BP is to cut E. but this might have an (indirect) effect on R, which immediately becomes clear to the manager.

So far we have assumed that the user provides specific values, possibly more than one, interactively. In addition, it is possible for the user to provide a whole time series of values (vector) for a parameter.

### Money Search Engines

Since all the parameters in the scheme may be converted into money surface units as described hereinabove, the present invention provides a tool for each manager to search the sub-scheme that he or she is responsible for. The search can be filtered according to money surfaces (i.e., search only for amounts within a specific range). This allows the manager to identify risks (amounts of money missing) or opportunities (amounts of money that can be gained) with a few button clicks.

### Data Mining

The present invention allows extremely powerful data mining capabilities, which could not be available without it. This is due to the fact that the present invention is unique in capturing the dependency structure of parameters in the organization.

Data mining is becoming critical for many organizations: it allows them to detect patterns in their data, and gain more insights on opportunities and risks for the organization. Data mining is a type of unsupervised statistical machine learning, and sometimes relies on sophisticated mathematics and algorithms. These are intended for discovering patterns in the data, typically in the form of high correlations between seemingly unrelated parameters, indicating their may be some causal relationship among the parameters.

The present invention includes a basic algorithm for data mining, and includes an interface for utilizing any arbitrary data mining algorithm. The main power of the present invention is in utilizing the scheme structure, which provides valuable hints for the data mining algorithms. This may be understood by realizing that data mining essentially amounts to computing correlations among different variables. This process is exponential, or prone to combinatory explosion. This means that the number of computations grows exponentially with the number of your parameters, making it infeasible to make a complete analysis of the data. This cannot be solved by simply adding more computation power, because the growth is exponential.

Thus, data mining techniques specialize in pruning, that is, in methods and heuristics which will minimize the number of computations, or the numbers of correlation comparisons among parameters. The present invention's constraint scheme provides invaluable pruning hints for the data mining algorithms.

Specifically, for each parameter p in the scheme we define a set of children C(p), such that p′εC(p) [symbol] there is a formula f, p=f(p′, . . . ). Next we define the transitive closure of this relation, the set of all descendants of p, D(p). We note that if p′ε(p) then, clearly, p is dependent on the value of p′, so there is no point in trying to test whether there is a correlation between them. This rule gives us a very useful heuristic for pruning the data mining algorithm.

The structure imposed by the scheme may provide additional heuristics and principles for pruning; For example, we can allow the user to fine tune the data mining algorithm and look for specific rules, in terms of the distance between parameters. The distance may be defined according to the scheme. Another aspect is the level. Distance is “horizontal”, and level is “vertical”; depth.

The shortest path between two parameters may be computed. If one of them is dependent on the other, the path will only be “vertical”, say n levels up or down. Otherwise, we will need to go in one direction (up or down) n levels, and then m levels in other directions. These numbers <m,n> denote the distance between the two parameters, and may serve for prioritizing the data mining algorithm.

Alternatively, the semantics of the data may serve for the pruning. For example, the user may specify looking for patterns of dependencies (correlations) between parameters with specific properties, e.g., sales and product price.

### Additional Machine Learning

A further feature of the present invention is the ability to observe and automatically fine tune these parameters, regardless of the algorithm itself.

The engine may also learn to be very sensitive to certain opportunities and risks. During normal course of operation of the system, users will encounter alarms that signal risks and opportunities. Users may rate these alarms. The system can then learn to rate alarms according to user rating. For example, alarms related to parameters with similar identities, or with similar ranges, will be rated higher.

The above examples and description have been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for the management of data comprising the steps of:
collecting and storing sets of records in a database within memory;
associating multi-dimensional matrices known as parameters with each of the sets of records; and
processing the parameters of the sets of records.

2. The method of claim 1, wherein the step of associating comprises the steps of:
defining the dimensions of each of said parameters, said dimensions comprising zero or more properties configured to access said multi-dimensional matrices; and
defining each of said parameters in relation to each of the dimensions of each of said parameters.

3. The method of claim 2, wherein said dimensions further comprise at least one of a group of properties including a unique identifier, a name and a comment field.

4. The method of claim 2, wherein each of said parameters further comprises a time dimension.

5. The method of claim 4, wherein the time dimension for one of each of said parameters is different from the time dimension of at least one other of each of said parameters.

6. The method of claim 2, wherein each of said parameters further comprises a temporal resolution.

7. The method of claim 6, wherein the temporal resolution for one of each of said parameters maybe different from the temporal resolution of at least one other of each of said parameters.

8. The method of claim 4, wherein said time dimension comprises one of a group including constant, index and array time series.

9. The method of claim 1, wherein said step of processing comprises the step of applying at least one function to at least one of the elements of at least one parameter.

10. The method of claim 9, wherein the parameters and the at least one function associated with said at least one parameter form a network structure.

11. The method of claim 9, wherein the at least one function is a constraint and wherein the parameters and the at least one function associated with said at least one parameter form a constraint propagation network.

12. The method of claim 11, wherein the constraint has a format of C(x₁, . . . , xₙ), where C is the type of the constraint and x₁, . . . , xₙ are parameters.

13. The method of claim 11, wherein the constraint comprises a function having an inequality sign (=˜).

14. The method of claim 11, wherein the constraint propagation network comprises a non-directional relationship between input and output parameters.

15. The method of claim 14, wherein the output of one function becomes the input of another function.

16. The method of claim 2, wherein each of said parameters is defined as a tuple: <I, T, R>, where I is the identity, T is the data type, and R is the temporal resolution.

17. The method of claim 2, wherein each of said parameters is defined as a two-dimensional table with keys, wherein:
P={<p_{1,1}, . . . , p_{k,1},v₁, . . . , <p_{1,n}, . . . , p_{k,n},vₙ>}; and
wherein each tuple in the table is defined as an “entry”, each p_{i,j} is defined as a “property value” and each tuple p_{1,i}, . . . p_{k,i} is defined as an “entry key”.

18. A system for the management of data comprising:
a schema server;
a database server in communication with the schema server;
a web server in communication with the schema server; and
a user alerter in communication with the web server;
wherein the database server provides storage for sets of records;
and wherein the schema server is configured to associate multi-dimensional matrices known as parameters with each of the sets of records and to process the parameters of the sets of records within the memory of the schema server.

19. The system of claim 18, wherein said database server further provides storage for at a least one of a group including organization schema, data snapshots, alerts and system configurations.

20. The system of claim 19, wherein, the data snapshots are automatically updated whenever new data is input.

21. The system of claim 19, wherein on startup, the schema server reads organization schema and snapshot from the database into its memory and creates all containers, connectors, formulas and collectors associated therewith in its memory.

22. The system of claim 18, wherein said user alerter comprises a program located on a user's workstation, said program configured to alert the user to take actions in cases when organization objectives may be affected.

23. The system of claim 18, wherein said web server is configured used to produce HTML pages, said HTML pages comprising at least one of a group of sites configured to provide the common daily activities for regular users, to define and maintain the organization core schema and provide: starting and stopping the schema server for backups, setting system access privileges, removing unneeded data snapshots from database, configuring system parameters and viewing system faults logs.
